(19) United States
(12) Patent Application Publication
(10) Pub. No.: US 2019/0313598 A1
(43) Pub. Date: Oct. 17, 2019

(54) BIOSECURITY LIVESTOCK CONFINEMENT CRATE

(71) Applicant: Hansen Ag Solutions, Clive, IA (US)

(72) Inventors: Lloyd D. SNELL, Ames, IA (US); David MEESTER, Fresno, CA (US)

(21) Appl. No.: 16/382,551

(22) Filed: Apr. 12, 2019

Related U.S. Application Data
(60) Provisional application No. 62/657,140, filed on Apr. 13, 2018.

(51) Int. Cl. A01K 1/02; A01K 1/00; A01K 1/015

(52) U.S. Cl. CPC A01K 1/0218; A01K 1/0017; A01K 1/0047; E04B 5/48; A01K 1/0151; A01K 1/0076; A01K 1/0209

(57) ABSTRACT

An improved biosecurity livestock confinement crate system for safely confining and farrowing livestock. The confinement crate system improves the safety of the livestock and the user. The confinement crate system includes a containment area which houses an animal and is adjoined, and separated, by a rib structure in the configuration of a Flying-W. This configuration protects offspring of the animal in the adjoining safety area from being injured or killed.

### CROSS REFERENCE TO RELATED PATENT APPLICATION(S)

This present utility patent application claims priority to U.S. Provisional Patent Application No. 62/657,140 entitled “Improved Biosecurity Livestock Confinement Crate and Floor System” filed on Apr. 13, 2018, which is fully incorporated by reference herein.

### FIELD OF THE DISCLOSURE

This disclosure relates to an improved biosecurity livestock confinement crate used in agriculture and elsewhere. More specifically, and without limitations, this disclosure relates to an improved biosecurity livestock confinement crate for use in confining livestock, typically confined in a building structure.

### BACKGROUND OF THE DISCLOSURE

Livestock confinement crates including, but not limited to, farrowing crates, gestational crates, sow stalls, etc. are well known in the art. Livestock confinement crates are almost always comprised of metal and are used to enclose a sow or other livestock.

Livestock production regularly utilizes different production methods and facilities to more efficiently manage unique life cycle periods. For instance in pork production, a sow barn provides for the breeding, resting, and nursing of new production animals. Nursery barns are utilized to efficiently utilize barn space by raising piglets from weaning to a finishing barn starting weight. Finally, finishing barns complete the growth cycle to market weight.

Livestock confinement crates are commonly utilized on pork farms, ranches, and/or livestock ranches. A farrowing crate is commonly used to constrain a sow and protect the piglets which she is nursing.

Sow farming confinements are the means by which producers replenish their market hogs and provide products to consumers, such as, pork, bacon, gammon, and other hog protein products. Hog farming comes in a variety of forms including, but not limited to, intensive commercial farming, small scale farming, and free-range farming. In modern hog farming, a commercial farm may house thousands of hogs in climate controlled bio-security enhanced buildings.

Due to this high demand, exceeding a billion hogs annually harvested, hog production and producers must and do become more efficient in all areas. These areas range from water usage, calories to mass conversions, equipment cost and durability, and most importantly, animal well-being.

While in a sow barn, a sow typically spends an entire life in a single building, therefore, the interactions that the sow encounters are extremely important. Generally, the main types of interactions for sows include: (1) human/handler interactions; (2) interactions with their piglets; and (3) interactions with equipment including, but not limited to, livestock confinement crates such as farrowing crates. Injury or death due to equipment interactions including cuts and entrapment are important considerations in equipment design and function. Finally, systems designed to protect the herd from disease, improve human interactions, air filtration, and the minimization of disease breeding environments.

Current livestock confinement crates may restrict handler visual and physical access to the sow. Restricted access increases the potential for injury of the handler during movement and health and well-being interactions.

With the high demand for hogs, the loss of a piglet due to a negative interaction between the sow and the piglet which results in injury or death is unacceptable. The sow/piglet interaction must provide safe zones for nursing and transition zones at the head and rear of the sow. Furthermore, the crate must allow the piglets to not become trapped between the sow and the confinement equipment, either while nursing or during the sow's motions, such as standing up, lying down, rolling, or other activities. The confinement must minimize or eliminate all sharp corners and edges which could cause injury. Not all confinement systems, due to design and manufacturing methods, control these requirements.

A confinement sow facility most importantly must maintain a healthy environment that is bio-safe. In a modern facility, bio-safe means air filtration, waste management, and minimization of areas that promote the growth of disease. Not all confinement equipment designs eliminate the internal cavities that promote disease growth. Most notably, these spaces are created by confinement equipment built of square, rectangular, or round structural tubing or pipe. Furthermore, when these hollow forms are galvanized, additional holes are required for the process to prevent structural damage. These unclosed holes allow access to the entire internal volume of the structural tubing or pipe. An internal volume that is warm, dark, wet, and inaccessible for cleaning. A perfect location for the hosting of disease and pests.

Current livestock confinement crates including, but not limited to, farrowing crates are bulky, expensive, and require significant assembly effort when delivered. Furthermore, current livestock confinement crates are designed without full concern for bio-security which results in uncleanable or difficult to clean elements, such as structural tubing. In a modern facility, and for purposes of this disclosure, biosecurity is the prevention of rapid disease transmission within the confinement system.

Current methods of fabrication for livestock confinement crates use various standard metal forms, such as rod, tubing, bar, and plate steel. Current livestock confinement crates utilize these primary materials to cut, form, and weld the pieces into a front, sides, a top, and a rear planar panel sub-assemblies. These sub-assemblies are shipped and assembled on location.

Furthermore, current livestock confinement utilizes numerous parts welded together which are more likely to fail and require more in barn repairs and maintenance.

Thus, it is an objective of this disclosure to provide a solution to these problems and more. This disclosure provides a means to obtain an improved operator interaction with the sow, increase piglet safety, greater concern for bio-security, increased durability through design and manufacturing, and lower cost by utilizing more efficient manufacturing methods. This disclosure further provides an improved biosecurity livestock confinement crate system that is easy to ship and transport, easy to assemble, requires minimal installation time in new or retrofit facilities, etc. Additionally, the disclosure herein solves numerous problems facing the hog confinement facilities. These problems include, but are not limited to, stability of the crate system; rigidity and durability of the crate system; etc. Finally, this disclosure introduces a farrowing crate system that utilizes advanced manufacturing solutions to reduce cost and improve component, sub-assemblies and final assembly function and durability.

Therefore, for all the reasons stated herein, there is a need in the art for an improved biosecurity livestock confinement crate system for safely confining and farrowing livestock.

Thus, it is an object of the disclosure to provide an improved biosecurity livestock confinement crate system that improves upon the state of the art.

Another object of the disclosure is to insure facility operators are safe while interacting with the animal.

Yet another object of the disclosure is to provide an improved biosecurity livestock confinement crate system that is easy to use and maintain.

Another object of the disclosure is to provide an improved biosecurity livestock confinement crate system that is efficiently manufacturable.

Yet another object of the disclosure is to provide an improved biosecurity livestock confinement crate system that is relatively more affordable.

Another object of the disclosure is to provide an improved biosecurity livestock confinement crate system that is easy to assemble.

Yet another object of the disclosure is to provide an improved biosecurity livestock confinement crate system that can be assembled and disassembled quickly.

Another object of the disclosure is to provide an improved biosecurity livestock confinement crate system that retains animal contaminants in a designated contaminant area.

Yet another object of the disclosure is to provide an improved biosecurity livestock confinement crate system that is safe and meets the requirements for extended animal confinement within the crate.

Another object of the disclosure is to provide an improved biosecurity livestock confinement crate system that is safe for the animals engaging the animal within the crate.

Yet another object of the disclosure is to provide an improved biosecurity livestock confinement crate system that separates livestock but still allows for a litter of livestock to nurse.

Another object of the disclosure is to provide an improved biosecurity livestock confinement crate system that keeps livestock forward in the crate.

Yet another object of the disclosure is to provide an improved biosecurity livestock confinement crate system that feeds livestock.

Another object of the disclosure is to provide an improved biosecurity livestock confinement crate system that is bio-secure.

Yet another object of the disclosure is to provide an improved biosecurity livestock confinement crate system that can quickly pass animal contaminants.

Yet another object of the disclosure is to provide an improved biosecurity livestock confinement crate system that is easy to clean.

Another object of the disclosure is to provide an improved biosecurity livestock confinement crate system that is structurally sound.

Yet another object of the disclosure is to provide an improved biosecurity livestock confinement crate system that allows livestock to stand or lay down without causing injury or death to any of the litter.

Another object of the disclosure is to provide an improved biosecurity livestock confinement crate system that is stable.

Yet another object of the disclosure is to provide an improved biosecurity livestock confinement crate system that can house large animals and withstand the forces generated by large animals.

Another object of the disclosure is to provide an improved biosecurity livestock confinement crate system that is resilient.

Yet another object of the disclosure is to provide an improved biosecurity livestock confinement crate system that provides some flexibility to accommodate livestock.

Another object of the disclosure is to provide an improved biosecurity livestock confinement crate system that can contain livestock in a singular orientation.

Yet another object of the disclosure is to provide an improved biosecurity livestock confinement crate system that limits livestock's vertical motion.

Another object of the disclosure is to provide an improved biosecurity livestock confinement crate system that allows proper ventilation.

Yet another object of the disclosure is to provide an improved biosecurity livestock confinement crate system that reduces entrapment of contaminants.

Another object of the disclosure is to provide an improved biosecurity livestock confinement crate system that minimizes risk of injury or death to the animal during nursing.

Yet another object of the disclosure is to provide an improved biosecurity livestock confinement crate system that minimizes tools for assembly.

Another object of the disclosure is to provide an improved biosecurity livestock confinement crate system that can be quickly final assembled on site.

Yet another object of the disclosure is to provide an improved biosecurity livestock confinement crate system that can be formed and manufactured by high efficiency manufacturing processes.

Another object of the disclosure is to provide an improved biosecurity livestock confinement crate system that is easy to ship.

Yet another object of the disclosure is to provide an improved biosecurity livestock confinement crate system that is light and durable without reducing structural performance.

Another object of the disclosure is to provide an improved biosecurity livestock confinement crate system that includes an integrated floor structure.

Another object of the disclosure is to provide an improved biosecurity livestock confinement crate system that is customizable.

Yet another object of the disclosure is to provide an improved biosecurity livestock confinement crate system that accommodates manufacturing deviations in assembly.

Another object of the disclosure is to provide an improved biosecurity livestock confinement crate system that can be adapted to other primary and secondary systems.

These and other objects, features, or advantages of the disclosure will become apparent from the specification, figures and claims.

### SUMMARY OF THE DISCLOSURE

An improved biosecurity livestock confinement crate system for safely confining and farrowing livestock is presented. The system enables utilization of high-volume manufacturing to minimize parts count, welding, directs labor costs during manufacturing, installation, and utilization; while maximizing robustness and functionality.

The livestock confinement crate system presented improves upon the safety of the livestock and the user(s). The livestock confinement crate system presented includes a designated containment area which houses a parent livestock. The parent livestock has access to feed and the ability to stand or lay down. The containment areas are adjoined, and separated, by the Flying-W configuration of the rib structure. The sow confinement area allows the piglets to transfer to opposing containment areas through safe zones at the head and rear of the sow. Furthermore, this configuration protects a litter of livestock in the adjoining safety area from being injured or killed when a parent livestock stands up, lies down, or repositions. The configuration is unique in that it protects the litter while still allowing the sow to lie down.

The livestock confinement crate system is structurally sound but also flexible due to the unique design. The livestock confinement crate area is easy to assemble and safe to use. Previous methods of creating and assembling components of a livestock confinement crate such as a farrowing crate were burdensome, expensive, and required more hardware to assemble and secure sub-assemblies of the crate assembly. The new methods and components described herein solve these issues in the art that have remained unresolved for many years. The livestock confinement crate system presented herein utilizes novel components in a unique way to create a safe and useful structure for the livestock industry that can be assembled quickly and efficiently. The livestock confinement crate system presented herein creates a bio-secure environment that reduces contaminants which have harmful effects on livestock and livestock litters, especially in the nursing process.

### BRIEF DESCRIPTION OF THE DRAWINGS

FIG. 1 is a perspective view of an improved biosecurity livestock confinement crate system;

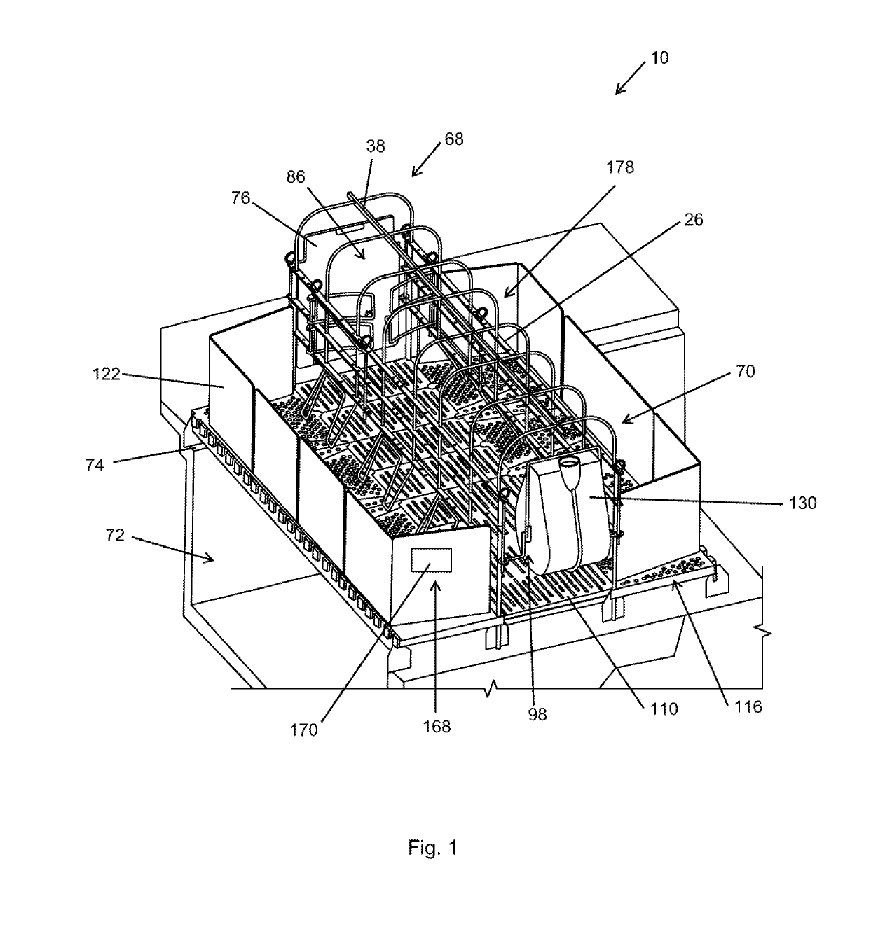

FIG. 2 is a perspective view of a partial improved biosecurity livestock confinement crate as shown in FIG. 1; the view showing at least one rib; the view showing at least one horizontal plate; the view showing at least one center plate; the view showing at least one end rod; the view showing a plurality of foot plates;

FIG. 3 is a section view of the improved biosecurity livestock confinement crate as shown in FIG. 1; the view showing a containment area; the view showing a safety area;

FIG. 4 is a is a left side elevation view of the improved biosecurity livestock confinement crate shown in FIG. 1; the view showing at least one rib; the view showing at least one horizontal plate; the view showing at least one center plate; the view showing at least one end rod; the view showing a plurality of foot plates;

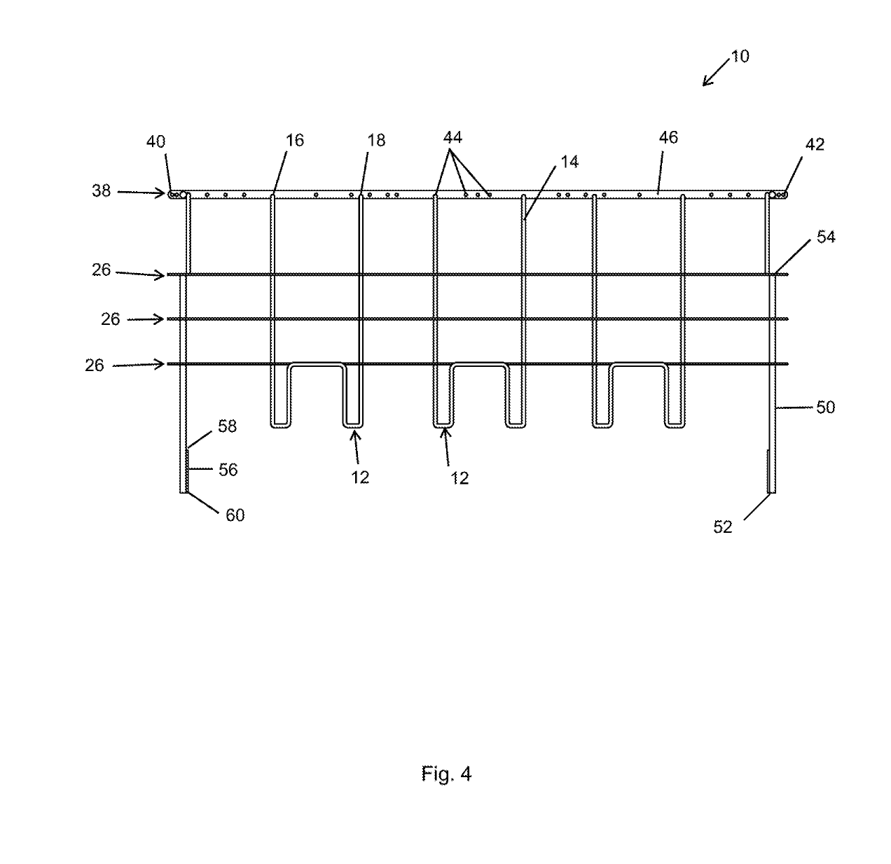

FIG. 5 is a top elevation view of the improved biosecurity livestock confinement crate system shown in FIG. 1; the view showing at least one rib; the view showing at least one horizontal plate; the view showing at least one center plate; the view showing at least one end rod; the view showing a plurality of foot plates;

FIG. 6 is a perspective view of a partial improved biosecurity livestock confinement crate as shown in FIG. 1; the view showing a floor assembly connected to a lip of a containment pit;

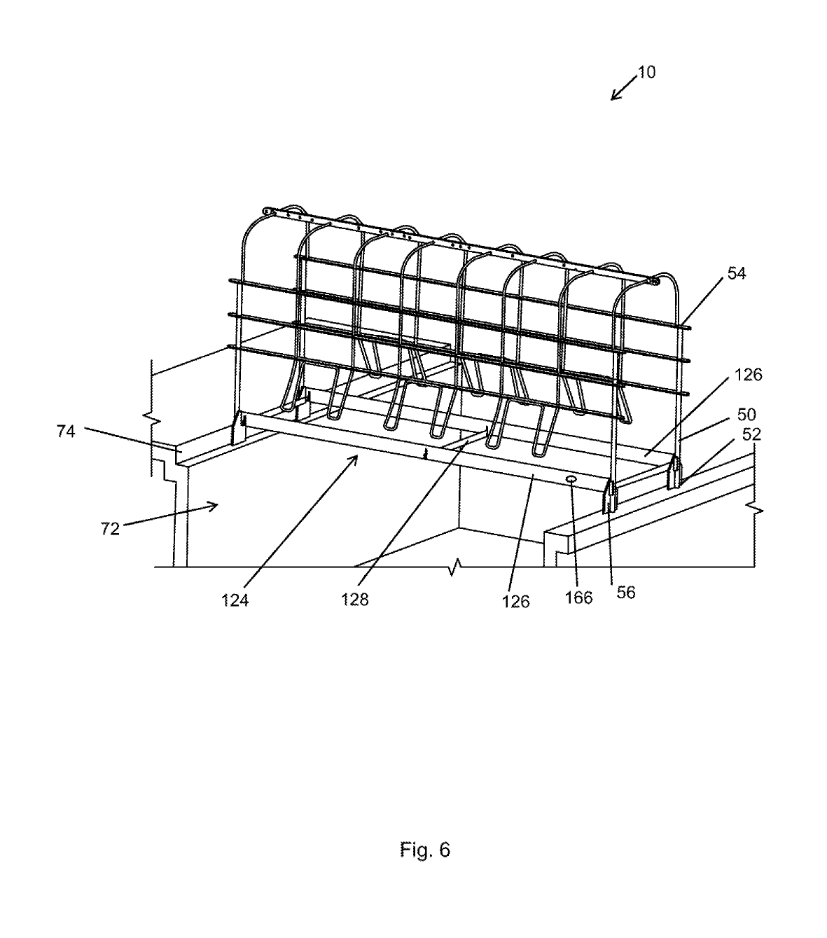

FIG. 7 is a perspective view of a partial improved biosecurity livestock confinement crate as shown in FIG. 1; the view showing a floor assembly connected to a lip of a containment pit; the view showing adjacent floor assembly installations installed for use with a safety area floor;

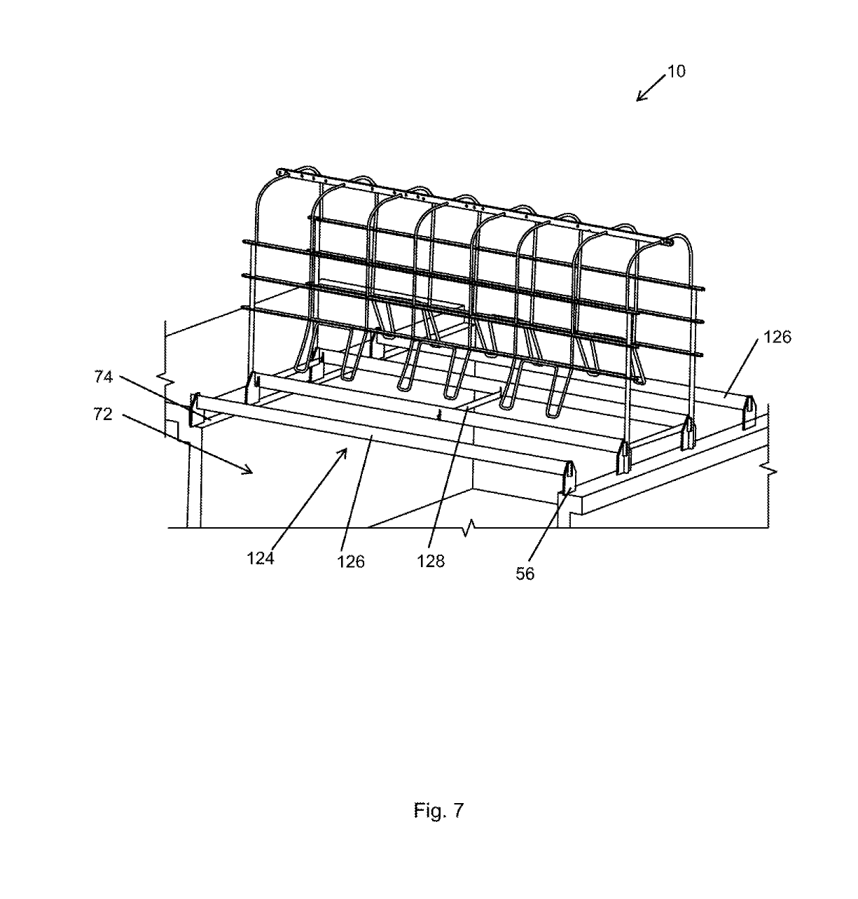

FIG. 8 is a perspective view of a partial improved biosecurity livestock confinement crate as shown in FIG. 1; the view showing a floor assembly connected to a lip of a containment pit; the view showing adjacent floor assembly installations installed for use with a safety area floor; the view showing a first (front) door in a closed position;

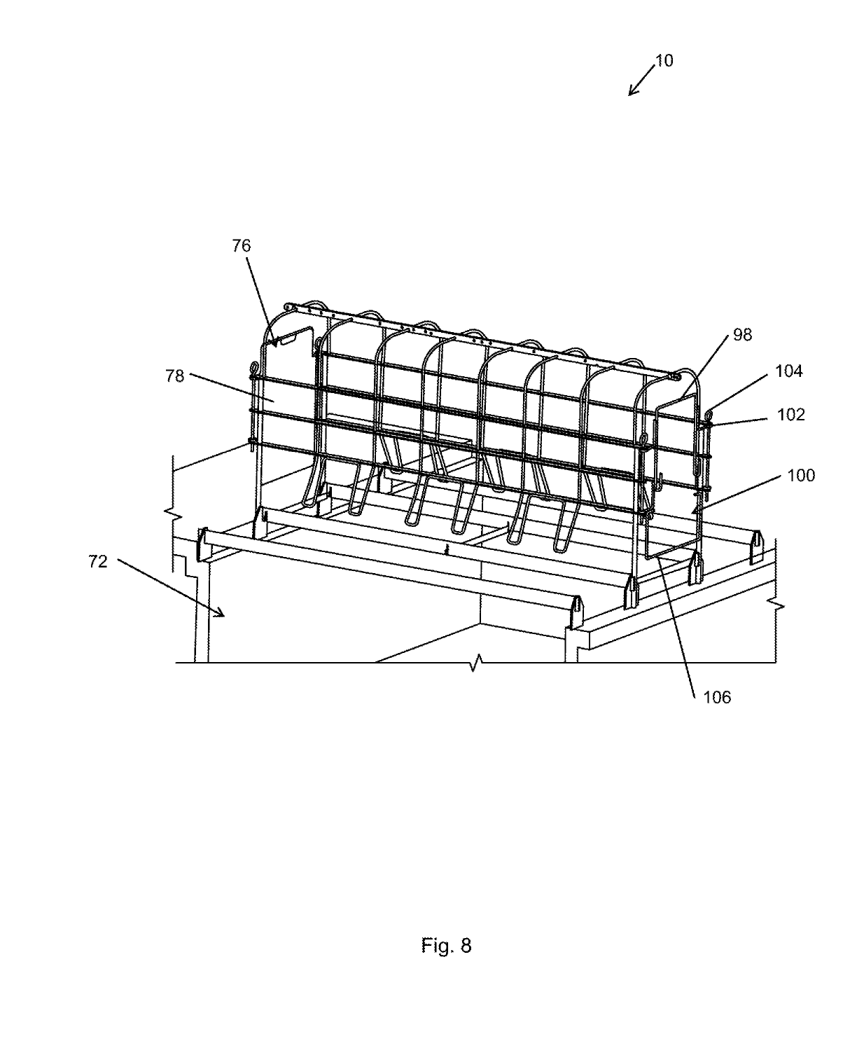

FIG. 9 is a close up perspective view of a partial improved biosecurity livestock confinement crate as shown in FIG. 1; the view showing a floor assembly connected to a lip of a containment pit; the view showing adjacent floor assembly installations installed for use with a safety area floor; the view showing a second (rear) door in a closed position; the view showing a supplemental door in a closed position;

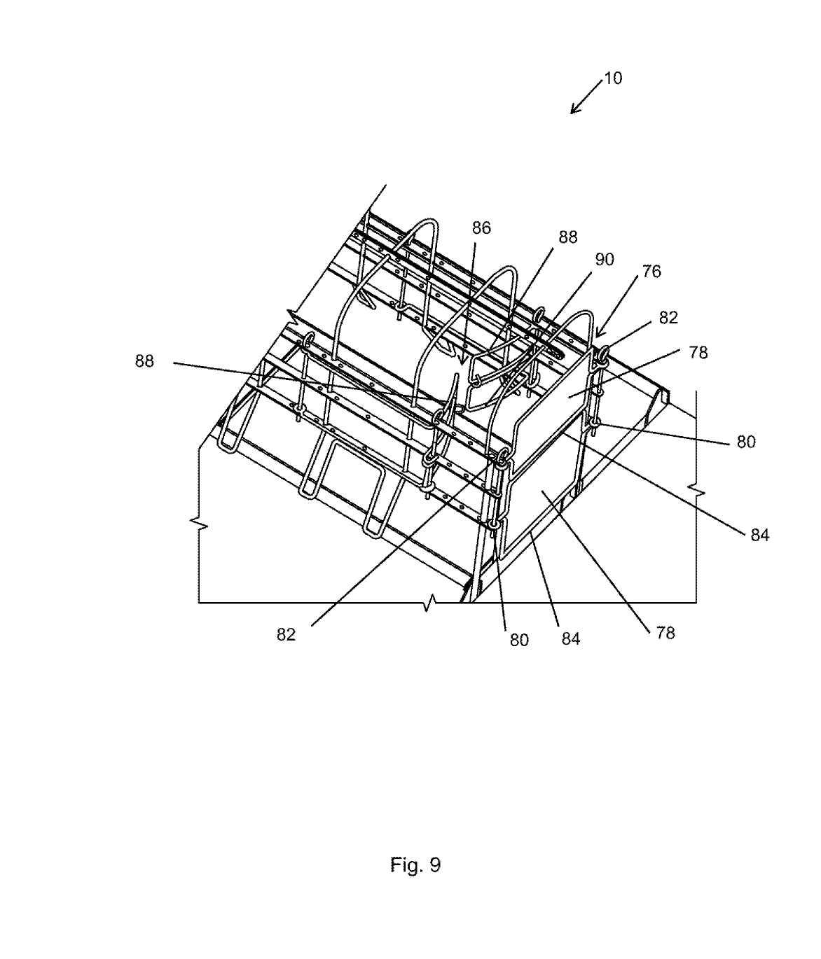

FIG. 10 is a close up perspective view of a partial improved biosecurity livestock confinement crate as shown in FIG. 1; the view showing a floor assembly connected to a lip of a contaminant pit; the view showing adjacent floor assembly installations installed for use with a safety area floor; the view showing a first door in a closed position; the view showing a supplemental door in an open position;

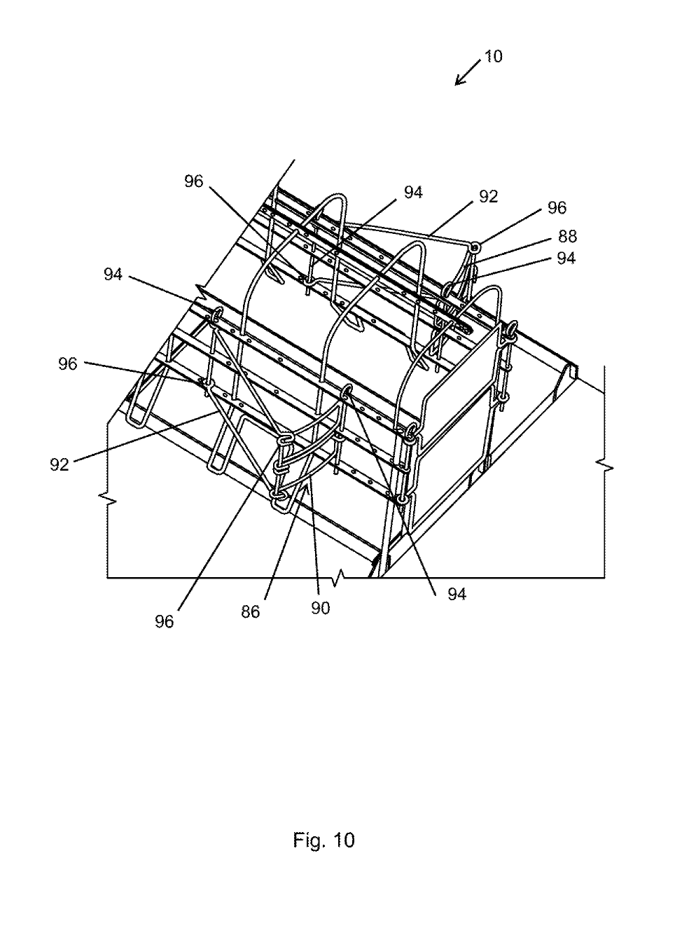

FIG. 11 is a close up perspective view of a partial improved biosecurity livestock confinement crate as shown in FIG. 1; the view showing a floor assembly connected to a lip of a containment pit; the view showing a feeder; the view showing a feeder in a closed position;

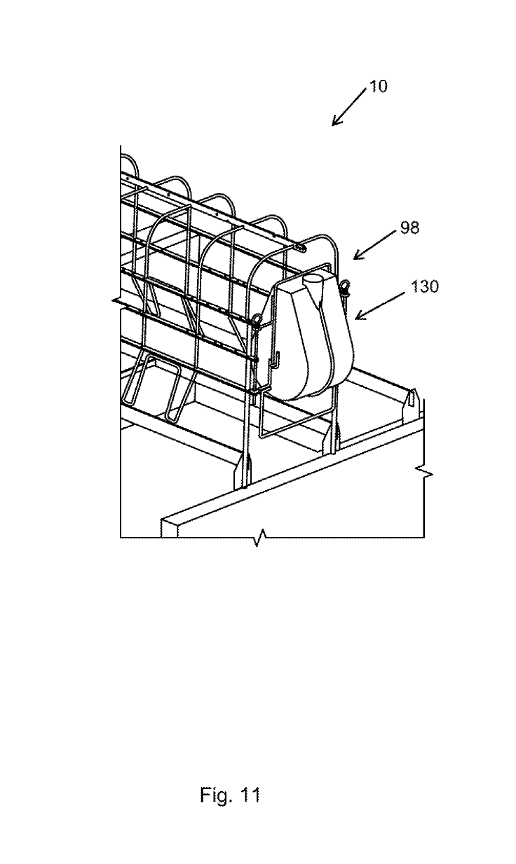

FIG. 12 is a perspective view of a feeder;

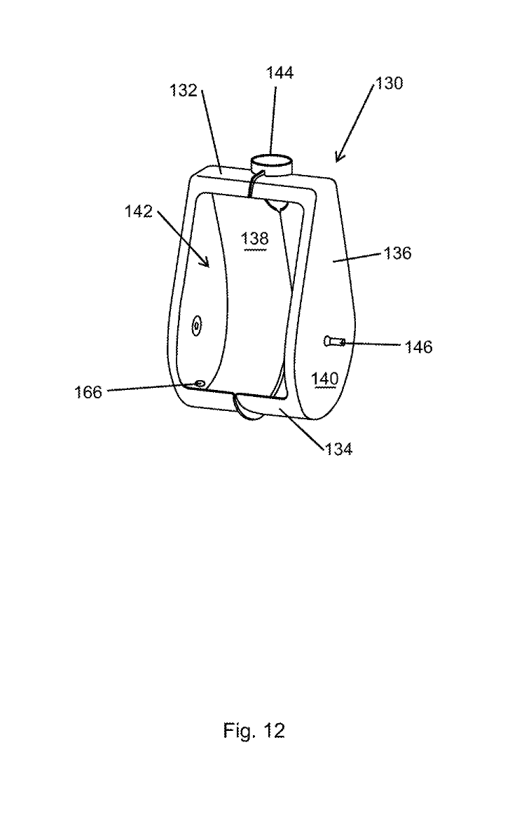

FIG. 13 is a side elevation view of a feeder;

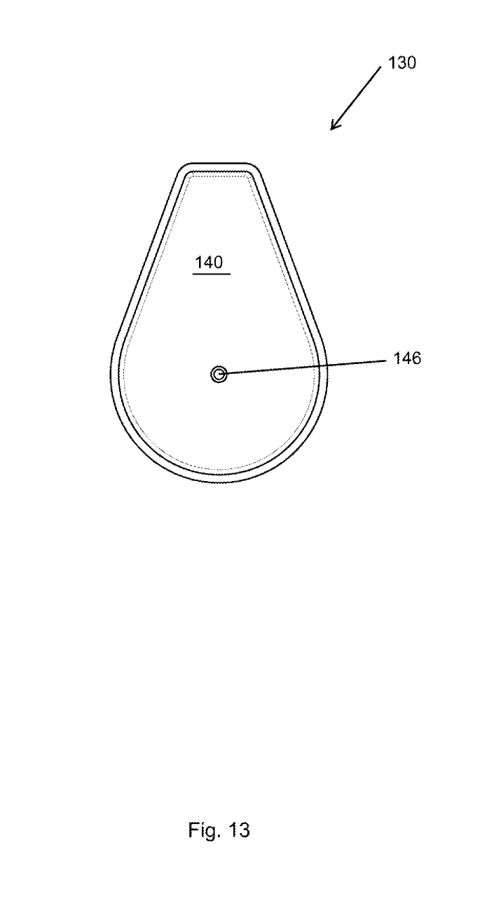

FIG. 14 is a close up perspective view of a partial improved biosecurity livestock confinement crate as shown in FIG. 1; the view showing a floor assembly connected to a lip of a containment pit; the view showing a feeder; the view showing a floor panel;

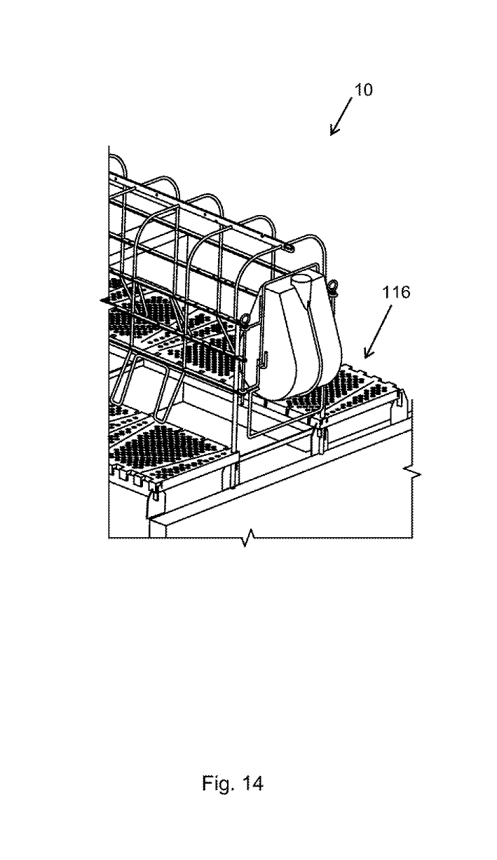

FIG. 15 is a perspective view of a floor panel;

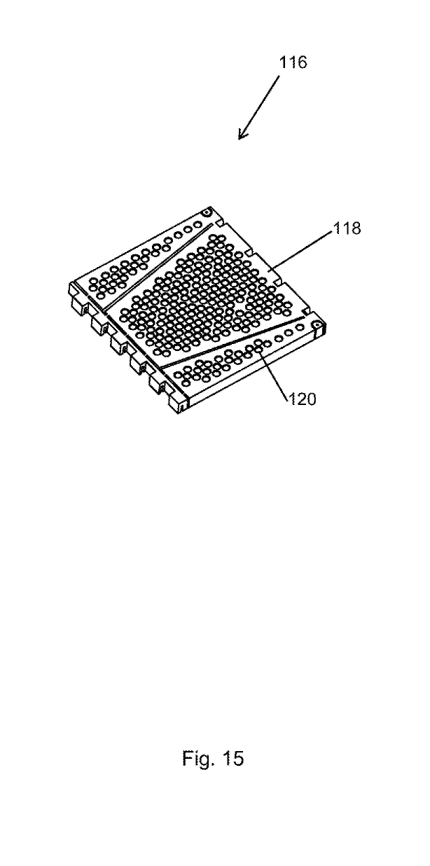

FIG. 16 is a perspective view of a floor panel;

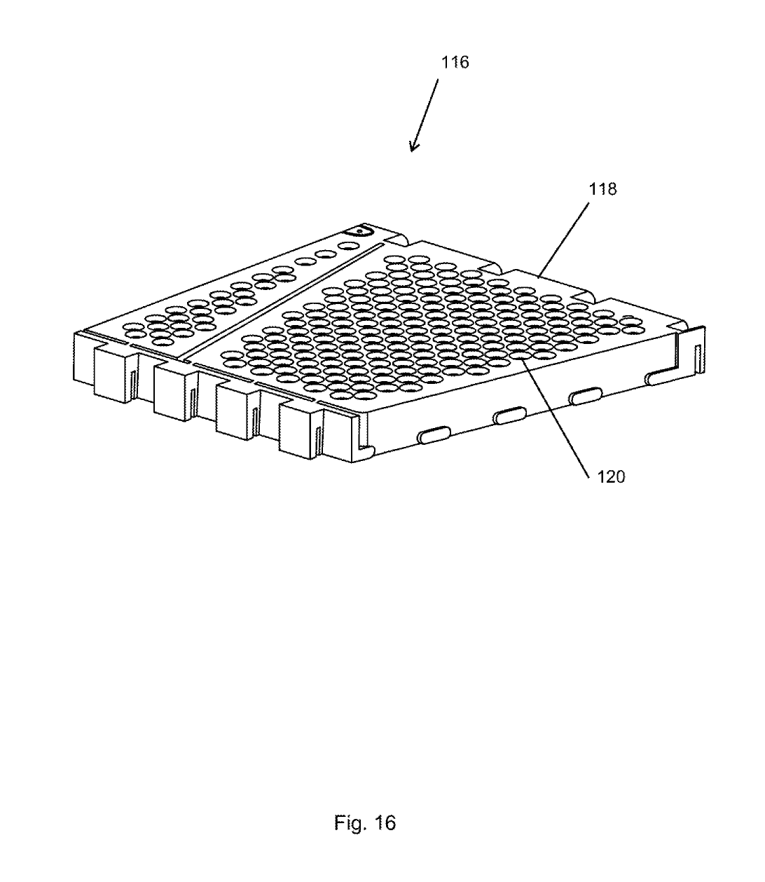

FIG. 17 is a close up perspective view of a partial improved biosecurity livestock confinement crate as shown in FIG. 1; the view showing a floor assembly; the view showing a containment area floor; the view showing a safety area floor;

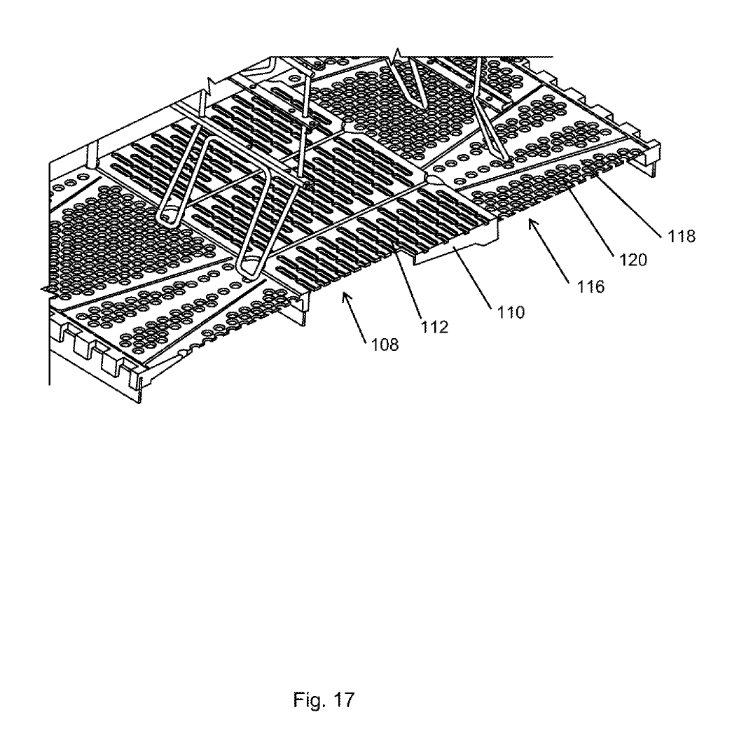

FIG. 18 is a close up perspective view of a containment floor panel and a bottom perspective view of a containment floor panel; the view showing a plurality of tabs; the view showing interconnecting floor panels;

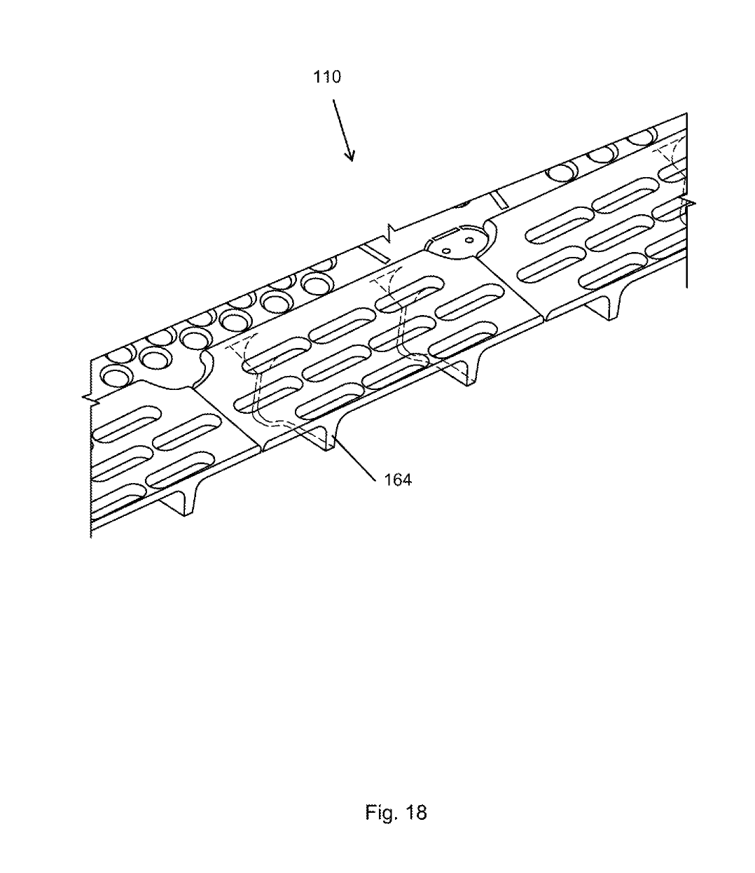

FIG. 19 is a bottom perspective view of a containment floor panel; the view showing a plurality of tabs; the view showing interconnecting floor panels;

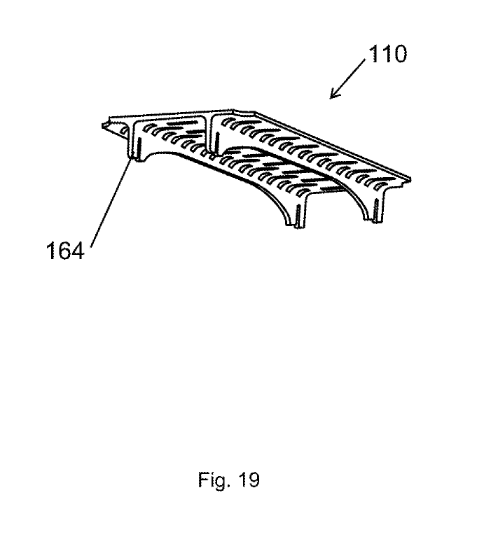

FIG. 20 is a perspective view of an improved biosecurity livestock confinement crate as shown in FIG. 1; the view showing containment panels; the view showing the containment panels inserted in groves in the interconnecting floor panels the view showing nursery panels; the view showing nursery panels operably connected to floor panels;

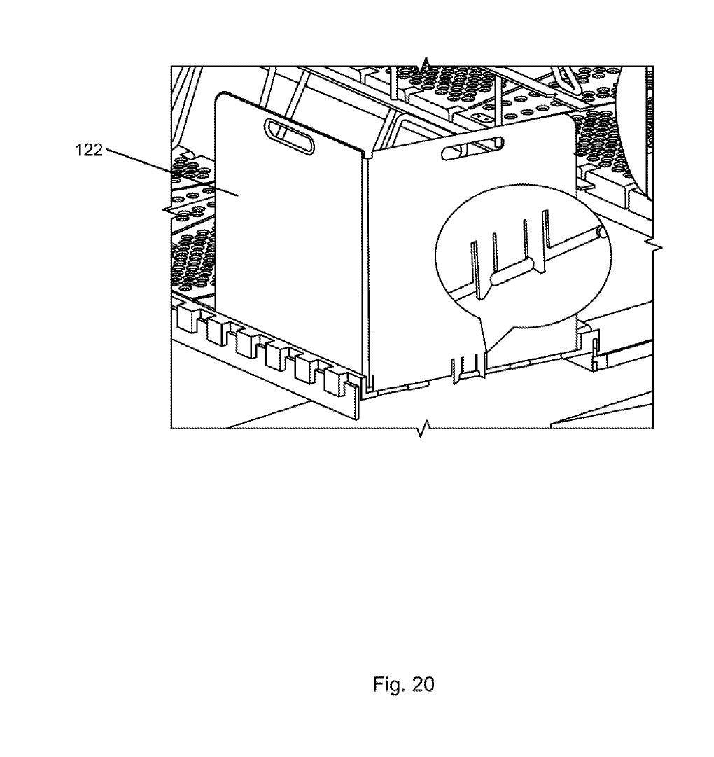

FIG. 21 is a perspective view of a heat lamp rod;

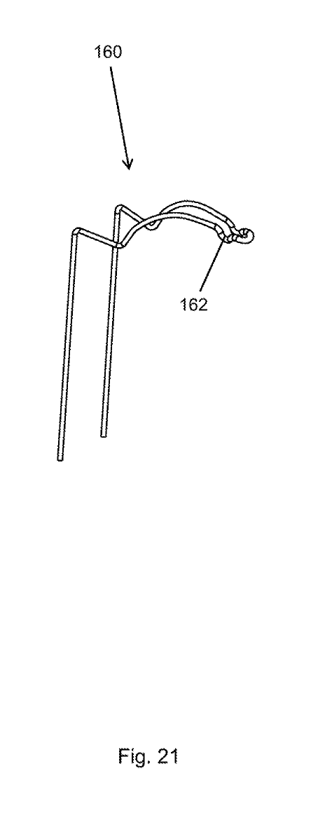

FIG. 22 is a close up perspective view of a partial improved biosecurity livestock confinement crate as shown in FIG. 1; the view showing a heat lamp; the view showing the heat lamp operably connected to the improved biosecurity livestock crate;

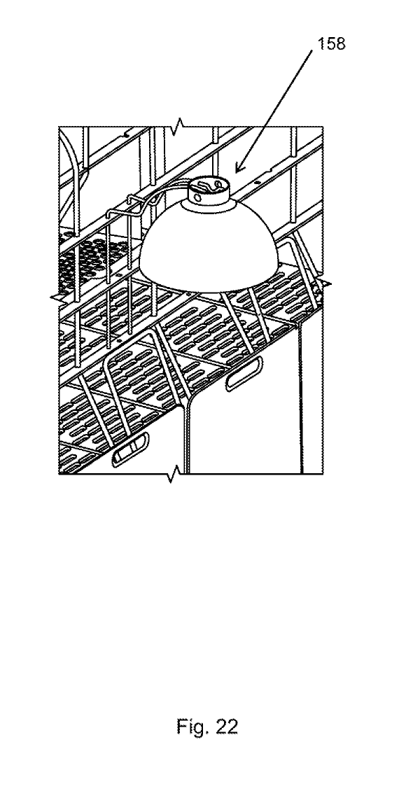

FIG. 23 is a close up perspective view of a partial improved biosecurity livestock confinement crate as shown in FIG. 1; the view showing a water tree; the view showing the water tree operably connected to the improved biosecurity livestock confinement crate.

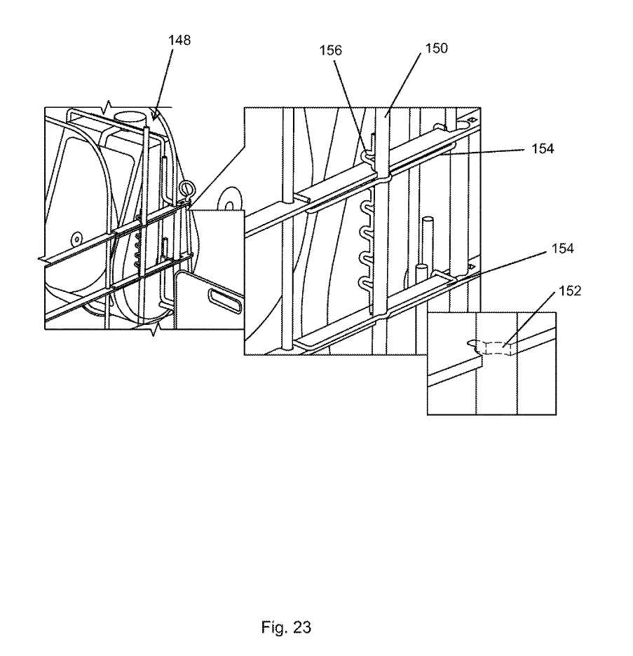

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

System:

With reference to the figures, an improved biosecurity livestock confinement crate system 10 (or simply “system 10” or “a confinement crate system 10”) for confining livestock is presented. The system 10 is used in association with many purposes involving livestock including, but not limited to, a farrowing crate, to limit livestock exposure to negative interactions, and increase safety of livestock and others. Additionally, system 10 provides the ability to achieve improved biosecurity within livestock confinements. As provided above, and for purposes of this disclosure, biosecurity is the prevention of rapid disease transmission within a confinement system. Important in biosecurity is a confinement system that supports direct flow of bio-waste into a waste transmission system below the floor. Wherein bio-waste is any animal discharge, but predominately, feces and urine. System 10 may be utilized in association with any type of livestock including, but not limited to, hogs without departing from the scope of the disclosure. Furthermore, the term “hog” is utilized throughout the disclosure to refer to swine, pigs, hogs, and the like without any limitation. System 10 is used in association with a Flying-W assembly, or at least one rib 12, at least one horizontal plate 26, at least one center plate 38, at least one end rod 50, and at least one foot plate 56.

In the arrangement shown, as one example, the flying w assembly is configured of the at least one rib 12, the at least one horizontal plate 26, the at least one center plate 38, the at least one end rod 50, and the at least one foot plate 56 which forms a containment area 66. An additional area, that may form part of the system 10, is a safety area 114, which may be configured adjacent to the containment area 66.

System 10 may be used in association with one or more doors. Doors of system 10 are configured to contain and position livestock. System 10 may be used in association with a first door 76, also referred to as a rear door, a second door 98, also referred to as a front door 98, and a supplemental door 86.

System 10 may also be used in association with at least one floor assembly. The floor assemblies of system 10 are configured to hold livestock and provide a bio-secure means of facilitating in the passing of waste, as well as other functions to be further described and incorporated herein. System 10 may be used in association with a containment floor 110 as well as a safety floor 116. The containment floor 110 may also be referred to as a containment area floor 110 or a confinement area floor 110 without departing from the scope of the disclosure. The safety floor 116 may also be referred to as a safety area floor 116 without departing from the disclosure. Additionally, system 10 may be used in association with a floor beam assembly 124 which stabilizes the floor. Floor beam assembly 124 may include a beam 126 and a stiffener 128.

System 10 may be used in association with other features as well. System 10 may be used in association with a feeder 130, a water tree 148, a heat lamp 158, a plurality of tabs 164, a plurality of sensors 166, a management hardware 168, an application 170, the application being associated with a user and an interne enabled or controller enabled device such as a mobile device.

The system 10 is used in association with all of these components, among other features, systems, and components as is described herein and shown in the figures.

Rib (Flying-W):

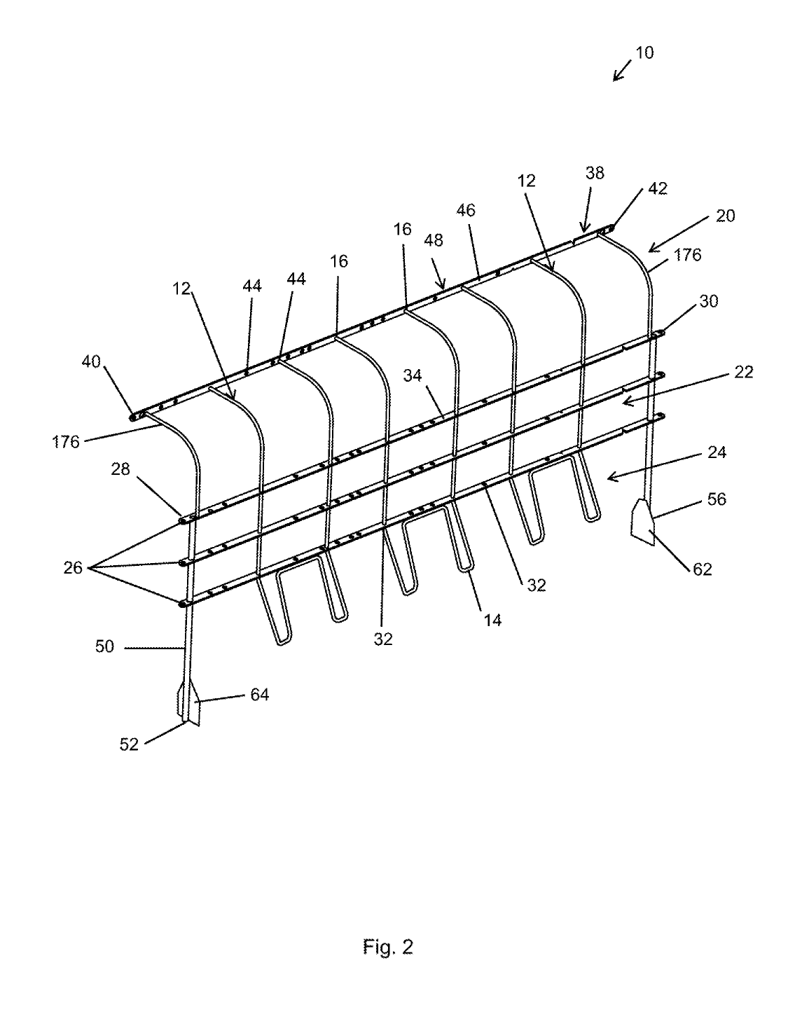

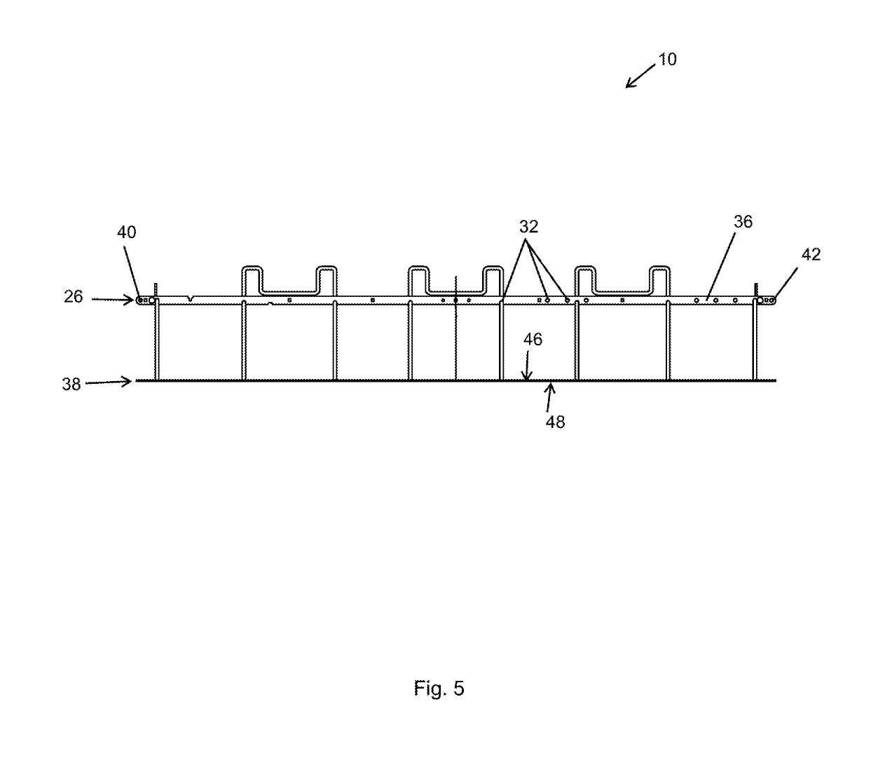

In the arrangement shown, as one example, the system 10 is used in association with at least one rib 12. The at least one rib 12 may be formed of any suitable size, shape and design and is configured to provide the 3-dimensional, structural member of the main body of the confining crate. The at least one rib 12 is a solid sectional profile, which may also be formed with materials having an inner sectional profile and an outer sectional profile. The at least one rib 12, also referred to as Flying-W, is configured to create the new and important structural strength for the system 10 presented herein. The at least one rib 12 is formed into three planes to further increase the structural strength. In other words, the at least one rib 12 is configured to provide the crate with its shape and strength. Furthermore, a main function of the at least one rib 12 is also to create an easy means of creating welds that form the opposing assemblies FIGS. 2 and 5 of a confinement crate system 10. Said in one other way, the at least one rib 12 is configured to structurally increase the integrity, rigidity, and durability of a confinement crate system 10 while minimizing the material size and weight. These functions, as well as others, are hereby contemplated for use.

Furthermore, in one arrangement, as one example, the lower portion of the at least one rib 12 may include components of the Flying-W in multiple planes which are welded to opposing and parallel surfaces of the at least one horizontal plate 26 in order to increase structural strength with less material.

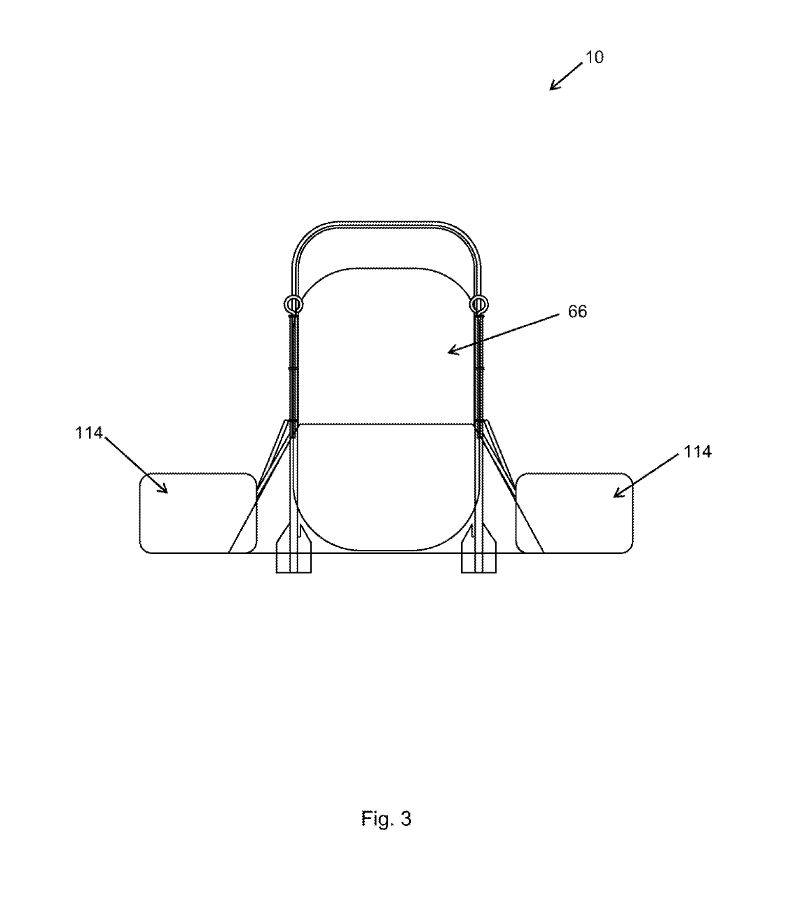

In the arrangement shown, as one example, the at least on rib 12 is formed of a continuous wire 14 extending a length from a first end 16 to a second end 18. The at least one rib 12 includes an upper portion 20 which is generally formed of an arc. The at least one rib 12 includes a middle portion 22 which is generally formed of a plane extending from a top horizontal plate 26 to a bottom horizontal plate 26. The at least one rib 12 includes a lower portion 24 which is shaped like a ‘W’. The at least one rib 12 includes in portion of the ‘W’ is not in the same plane as the entrance and exit section of the ‘W’. See FIG. 3. Further explained, the downward leg of the ‘W’ in contained in a slot on the inside of the horizontal bar. The inside of the ‘W’ extends back to the outer plane of the horizontal bar. The continuous wire then runs parallel and tangent to the exterior of the horizontal bar, then again returning to the initial plane and continues to next groove on the inside of the horizontal bar. Moving the continuous wire out of the original plane creating the structural strength required. However, any shape or configuration is hereby contemplated for use without departing from the disclosure.

In the arrangement shown, as one example, the at least one rib 12 is formed in a shape that looks like a ‘W’, i.e., the origin of the Flying-W naming. In this arrangement, the ‘W’ forms the lower portion 24 of the at least one rib 12. In the arrangement shown, as one example, the at least one rib 12 is formed of a continuous wire 14, or bar. In this arrangement, the Flying-W wire starts at the crate center plate 38, where the first end 16 is connected to the center plate 38. Center plate 38 to be further described herein.

In the arrangement shown, as one example, the at least one rib 12 extends in a normal, or parallel line (to the floor) from the center plate 38 before arcing vertically down toward the floor. In this arrangement, as one example, the continuous wire 14 passes through positioning slots 32 of the three horizontal plates 26. Position slots 32 and horizontal plates 26 to be further described herein. In this arrangement, as is shown, once the continuous wire 14, or bar passes through the positioning slots 32 of the horizontal plates 26, the continuous wire 14 bends outward creating space enough in the containment area 66 for the sow to lie down. Containment area 66 is further described herein.

Furthermore, in this arrangement of the shape of the at least one rib 12, as one example, the continuous wire 14 then bends horizontal to the floor for a distance before bending upwards away from the floor. In this arrangement, as is shown, this lower bend, which is located horizontal to the floor, is spaced a distance from the floor such that piglets escape to a safety area 114 from the containment area 66 is unrestricted. This space between the bottom of the lower portion 24 of the at least one rib 12 and the floor allows piglets to escape the containment area and avoid being injured or killed do to crushing or entrapment.

In the arrangement shown, as one example, after the continuous wire 14 of the at least one rib 12 bends back up toward the horizontal plate 26, the wire 14 is again bent parallel to the floor. In this arrangement, as is shown, the wire 14 then bends parallel to the horizontal plate 26 at a location which is closer to the horizontal plate 26 than the previous portion of horizontal wire 14 which extended parallel to the floor. In the arrangement shown, as one example, the continuous wire 14 extends downward again and repeats the shape, as referenced, such that the lower portion 24 of the continuous wire 14 creates a ‘W’ shape; when viewed from a side elevation.

In the arrangement shown, as one example, after the ‘W’ shape is formed by the lower portion 24 of the at least one rib 12, the continuous wire 14 then extends upward through the middle portion 22, once again, and through another set of positioning holes 32 of the three horizontal plates 26. In this arrangement, as one example, the continuous wire 14 then extends in an arcing manner through the upper portion 20 and back to the center plate 38.

In the arrangement shown, as one example, a Flying-W shape forms half the structure of the system 10 as this support high density shipping. However, other shapes are hereby contemplated for use that may be configured to provide stability and safety. Furthermore, other shapes, which may form the entire system 10, or in other words both sides of the system 10, are hereby contemplated for use. Other shapes may be any three-dimensional shape of forming a continuous or rebar wire 14 which can extend through positioning slots 32 and provide an easy to configure rib cage of the confinement crate system 10.

In the arrangement shown, as one example, the at least one rib 12 is comprised of a size that allows for the confinement crate system 10 to be utilized as a farrowing crate which can comfortably house a single sow. However, any other size of the at least one rib 12 are hereby contemplated for use without departing from the disclosure. Additionally, the thickness of the continuous wire 14, which forms the at least one rib 12, is comprised of a size that provides strength in order to contain a sow in a safe manner. However, any other size of continuous wire 14 is hereby contemplated for use without departing from the disclosure.

In the arrangement shown, as one example, three ribs 12, or three Flying-W configurations are used to provide a stable confinement crate system 10. However, any number, size, and 3-dimensional profile of ribs 12 may be used to configure an appropriately sized confinement crate system 10 without departing from the disclosure. For example, the system 10 may comprise one, two, three, four, five, six, seven, eight, nine, ten, or more ribs 12.

Furthermore, in the arrangement shown, as one example, the at least one rib 12 is sized so that the bottom horizontal portion of the lower portion 24 of the at least one rib 12 does not contact the floor. In this arrangement a piglet can fit underneath the lower portion 24 of the at least one rib 12. It is important to note that the term “piglets” is utilized throughout the disclosure. However, the term “piglets” shall be interpreted to mean any type of offspring of any livestock without departing from the scope of the disclosure.

In the arrangement shown, as one example, the bottom of the lower portion 24 is approximately 4-5 inches from the floor. However, other arrangements are hereby contemplated for use. For example, the bottom of the at least one rib 12 may be sized to be in contact with the floor, or the at least one rib 12 may be sized to be several feet or more, or anything in between such as larger piglets or other livestock can fit underneath the Flying-W configuration of the lower portion 24. Furthermore, the lower portion of the at least one rib 12 is sized such that a piglet could fit in between the two ‘U’ extensions which form the lower portion 24. However, any other size of ‘W’ configuration or other shape is hereby contemplated for use without departing from the disclosure.

In the arrangement shown, as one example, the at least one rib 12 is designed to provide a stable structure for the confinement crate system 10 while also providing a safe structure. In this arrangement, the design of the at least one rib 12 must be strong and rigid, yet flexible, not yielding, so as to limit negative interactions, such as when a sow collides with an interior component of system 10. In this way, the design of the at least one rib 12 is such that the bar has some flexibility such that a sow or piglet could collide with the bar with minimized injury and/or stress risk, but so that the continuous wire 14 still confines a large sow and exceed the material mechanical properties and yield.

For these reasons and others, in the arrangement shown, as one example, the design of the at least one rib 12 is such that the continuous wire 14 has some flexibility but due to the shape of the at least one rib 12, the bar is very stable and durable. The design of the continuous wire 14 is also configured to allow an easy assembly. For this reason, in the arrangement shown, as one example, the at least one rib 12 fits into the positioning slots 32 of the horizontal plates 26 and the center plates 38, if desired. In this way, as the arrangement shown displays, the at least one rib 12 is designed so the crate system 10 can be easily and quickly assembled and welded into a sub-assembly.

In the arrangement shown, as one example, the at least one rib 12 is located or positioned so as to form the main body of the cage of the confinement crate system 10. In the arrangement shown, as one example, three ribs 12 are positioned an equal distance from one another along the length of the center plate 38 and the horizontal plates 26. In the arrangement shown, as one example, the at least one rib 12 is positioned such that it is operably connected to the at least one horizontal plate 26. In this arrangement, as is shown, the at least one rib 12 is a continuous wire 14 positioned, and inserted through the positioning slots 32/44 such that the positioning slots 32/44 come into close and tight tolerances with the at least one rib 12. In this way, the rib 12 can be fit within the positioning holes 32/44 so that a structure is formed from these and other components, or the rib 12 can be welded or otherwise attached to the horizontal plates 26 and the center plate 38.

In the arrangement shown as one example, the at least one rib 12 is located as an extension from the center plate 38 such that the first end 16 of the continuous wire 14, forming the at least one rib 12, and the second end 18 of the continuous wire 14 connect at different points to the center plate 38; the center plate 38 being located at the top of the upper portion 20 of the at least one rib 12. In the arrangement shown, as one example, the continuous wire 14 of the at least one rib 12 is secured to the center plate 38 and the three horizontal plates 26 by welding.

In the arrangement shown, as one example, the three ribs 12 are positioned opposite the center plate 38 from three additional ribs 12. These two sets of ribs 12 form the cage of the system 10. In the arrangement shown, as one example, the six ribs 12 form the main body of the system 10 and are positioned to create a surface of a containment area 66 above the floor of the system 10. In this arrangement, as is shown, the ribs 12 are positioned between two doors or openings which form a rear door or first door 76 and a front door or second door 98. Any doors of the system 10 are further described herein. In this arrangement, as is shown, the sow is housed within the containment area 66 formed by the overarching plurality of ribs 12.

In the arrangement shown, as one example, the at least one rib 12 is formed of a continuous wire 14. In the arrangement shown, as one example, the at least one rib 12 is formed from wire on a CNC wire bender from a continuous coil of wire. However, the at least one rib 12 may be formed of any suitable material of appropriate size, shape, and design without departing from the disclosure.

In another example, the at least one rib 12 may be formed of rebar or another metal or metal tubing, including, but not limited to, rolled steel, aluminum wire, an alloy, a hollow tube, and the like. However, the at least one rib 12 may be formed of any other material suitable for the intended purpose including, but not limited to, metal, an alloy, a polymer, an enhanced polymer, composites, the like, or any combination thereof without departing from the disclosure. One disadvantage of using steel for the at least one rib 12 may be the weight of the steel. Therefore, it may be beneficial to contemplate a strengthened polymer or other composite material that is lighter than steel, yet durable. These alternative materials are hereby contemplated for use both in the at least one rib 12 and throughout system 10.

In the arrangement shown, in addition to the at least one rib 12, a partial rib 176 may be desired as an end piece of the confinement crate system 10. In this arrangement, as is shown in the example, the partial rib 176 is only an upper portion 20 of the rib 12. In this way, a partial rib 176 can be configured as the final connection from the top horizontal plate 26 to the center plate 38. As is shown in the example, the partial rib 176 is configured as an extension of the at least one end rod 50. In an alternative embodiment, a partial rib 176 may not be needed, or may not be utilized in the design. Partial ribs are used to meet user access to the animal to perform health care and monitoring.

In one arrangement, as one example, the at least one rib, the at least one horizontal plate (described below), and the at least one end rod (described below) are configured to create at least one confinement side assembly 178. The system 10 may comprise any number of confinement side assemblies 178 without departing from the scope of the disclosure. In one arrangement, as an example, two confinement side assemblies 178 are opposingly combined in order to confine an animal while allowing offspring of the animal to access the animal for purposes including, but not limited to, nursing and warming.

Horizontal Plate:

In the arrangement shown, as one example, the confinement crate system 10 is used in association with at least one horizontal plate 26. The at least one horizontal plate 26 may be formed of any suitable size, shape and design and is configured to provide horizontal support to the at least one rib 12. In other words, as is shown in the example, horizontal plate 26 is configured to increase the structural strength of the confinement crate system 10 due to horizontal loading by the animal. The structural strength of the confinement crate system 10 may be increased, if necessary, by increasing the number of horizontal plates 26 used in the system 10. The structural strength of the confinement crate system 10 may be modified to increase vertical strength, if necessary, by rotating into a vertical orientation in combination with a number of horizontal plates 26 used in the system 10.

Additionally, horizontal plate 26 may be configured as a containment feature of the confinement crate system 10. However, appropriate spacing of the at least one rib 12 may make the horizontal plate 26 null as a containment feature. In the arrangement shown, as one example, horizontal plate 26 is also configured to house, and/or attach, other various features of the confinement crate system 10. Some of these features include, but are not limited to, doors, end rods 50, drop rods 82, pivot bars 92, water tree 148, heat lamp 158, sensors 166, and a partial rib 176, among other components or features.

In the arrangement shown, as one example, the at least one horizontal plate 26 is a generally flat, rectangular, bar extending a length from a first end 28, to a second end 30. In the arrangement shown, as one example, horizontal plate 26 has a plurality of positioning slots 32 which extend through the horizontal plate 26 from the top 34 to the bottom 36. When the rectangular plate 26 is vertically oriented slots and holes are not required. When the horizontal plate 26 is vertically oriented the at least one rib 12 is tangent to the outside surface. When the horizontal plate 26 is vertically oriented the at least one rib 12 is tangent to the outside surface and welded.

In the arrangement shown, as one example, the horizontal plate 26 is slender is size, or thin, as measured from the top 34 to the bottom 36. In the arrangement shown, as one example, the horizontal plate 26 extends a length from a first end 28 to a second end 30, which extends the entire length of the confinement crate system 10, from a forward most end to a rearward most end. In the arrangement shown, as one example, the horizontal plate 26 is sized to be wider than the diameter, or width, of the continuous wire 14 of the at least one rib 12. In this way, as is shown in one example, the horizontal plate 26 is able to accept the at least one rib 12 in an appropriately sized positioning slot 32.

In the arrangement shown, as one example, the horizontal plate 26 is sized a length to provide an appropriate space, or confinement area 66, for a sow from at least the nose of the sow to the tail of the sow. However, any other size of a horizontal plate 26 is hereby contemplated for use. For example, a horizontal plate 26 which is a length long enough for one, two, three, four, five, six, seven, eight, nine, ten, or more sows is hereby contemplated for use.

In the arrangement shown, as one example, the at least one horizontal plate 26 is designed to provide stability and support to the system 10. In the arrangement as is shown, the at least one horizontal plate 26 is designed to prevent, or limit, horizontal movement of the at least one rib 12. In this way, the at least one horizontal plate 26 prevents the at least one rib 12 from moving horizontally by enclosing the at least one rib 12 in one, or more, of a plurality of positioning slots 32. Additionally, in the arrangement shown, as one example, the horizontal plate 26 is stabilized at each end by an end rod 50 which transfers any horizontal forces applied to the horizontal plate 26 to the ground. The end rod 50 is further described herein.

In the arrangement shown, as one example, the at least one horizontal plate 26 is designed to provide stability and support to the system 10. In the arrangement, as is shown, the at least one horizontal plate 26 is designed to prevent vertical movement of the at least one rib 12. In this way, the at least one horizontal plate 26 prevents the at least one rib 12 from moving vertically by the operable connection to of the horizontal plate 26 to the at least one rib 12 in one, or more, of a plurality of positioning slots 32. Additionally, in the arrangement shown, as one example, the at least one rib 12 may be welded to the horizontal plate 26. Additionally, in the arrangement shown, as one example, the horizontal plate 26 is stabilized at each end by an end rod 50 which transfers any horizontal forces applied to the horizontal plate 26 to the ground. In the arrangement shown, as one example, the horizontal plate 26 is spot welded to the end rod 50. The end rod 50 is further described herein.

In the arrangement shown, as one example, the horizontal plate 26 extends a length from a first end 28 to a second end 30, having an end rod 50 attached at each end. In the arrangement shown, as one example the horizontal plates 26 run in approximate parallel spaced relation to the floor for the entire length of the confinement crate system 10.

In the arrangement shown, as one example, the at least one horizontal plate 26 is located in the approximate middle when viewing the confinement crate 10 from a side elevation. However, the horizontal plate 26 may be located at any point vertically along the side, as is shown in the example, showing three horizontal plates 26. In the arrangement shown, as one example, the horizontal plate 26 has a plurality of ribs 12 attached at approximately the ⅓ point, the halfway point, and the ⅔ point when viewing from a side elevation. In this arrangement, the horizontal plate 26 is attached to ribs 12 at equal distance spacing along the horizontal plate 26.

In the arrangement shown, as one example, a plurality of horizontal plates 26 form part of the sidewall of the containment area 66. In this arrangement, as is shown, a plurality of horizontal plates 26 are spaced opposite a vertical plane following the center plate 38, and form the opposite sidewall of the containment area 66.

In the arrangement shown, as one example, the at least one horizontal plate 26 is attached to other features of the system 10 by welding. However, any other type or form of attachment means is hereby contemplated for use including, but not limited to, friction fit, bolting, threading, gluing, and the like. Furthermore, in the arrangement shown, as one example, six horizontal plates 26 are used in the design of the confinement crate system 10. However, any number of horizontal plates 26 is hereby contemplated for use including one, two, three, four, five, six, seven, eight, nine, ten, or more horizontal plate 26.

In the arrangement shown, as one example, the at least one horizontal plate 26 is made from flattened or plated steel. However, any other material which is adequate for forming the at least one horizontal plate 26 is hereby contemplated for use without departing from the scope of the disclosure. Other materials include, but are not limited to, hollow tube, polymers, enhanced polymers, other metal materials, composites, and/or any combination thereof.

Center Plate:

In the arrangement shown, as one example, confinement crate system 10 is used in association with a center plate 38. Center plate 38 may be formed of any suitable size, shape and design and is configured to connect the opposing sides of the main body (formed by the at least one rib 12) and to stabilize the confinement crate system 10 along the top of the system 10. In other words, the at least one center plate 38 is configured like a spine, connected to each of the at least one ribs 12. In the arrangement shown, as one example, the at least one center plate 38 is configured to provide both vertical and horizontal support to the at least one rib 12. In other words, as is shown in the example, center plate 38 is configured to increase the structural strength of the confinement crate system 10. The structural strength of the confinement crate system 10 can be increased, if necessary, by adding a plurality of center plates 38. Conversely, an alternative arrangement may not have a center plate 38.

Additionally, in the arrangement shown, as one example, center plate 38 is configured as a containment feature of the confinement crate system 10. Where the horizontal plate 26 is configured to contain the sow along the sides of the system 10, the center plate is configured to contain along the top of system 10. In the arrangement shown, as one example, center plate 38 is also configured to house, and/or attach, other features of the confinement crate system 10. Other features of the system 10 include, but are not limited to, doors, end rods 50, drop rods 82, pivot bars 92, water trees 148, heat lamp 158, sensors 166, a partial rib 176, among other components or features.

In the arrangement shown, as one example, the at least one center plate 38 is a generally flat, rectangular bar, arranged vertically and extending a length from a first end 40 to a second end 42. In the arrangement shown, as one example, center plate 38 has a plurality of positioning holes 44 which extend through the center plate 38 from the first side 46 to the second side 48.

In the arrangement shown, as one example, the center plate 38 is similar in size, shape and design to the at least one horizontal plate 26. In the arrangement shown, as one example, the at least one center plate 38 is slender, or thin, from the first side 46 to the second side 48. In the arrangement shown, as one example, the center plate 38 extends a length from a first end 40 to a second end 42, which extends the entire length of the confinement crate system 10; from a forward most end to a rearward most end. In the arrangement shown, as one example, the center plate 38 is sized to be wider than the diameter, or width, of the continuous wire 14 of the at least one rib 12. In this way, as is shown in one example, the center plate 38 is capable of accepting the continuous wire 14 of the at least one rib 12. In this way, as is shown in one example, the center plate 38 is able to accept the at least one rib 12 in one or more of a plurality of positioning holes or slots 44.

In the arrangement shown, as one example, the center plate 38 is comprised of a size to provide an adequate space for a sow from at least the nose of the sow to the tail of the sow. However, any other size and length of center plate 38 is hereby contemplated for use without departing from the disclosure. For example, a center plate 38 which is formed of a length long enough to house one, two, three, four, five, six, seven, eight, nine, ten, or more sows is hereby contemplated for use.

In the arrangement shown, as one example, the at least one center plate 38 is designed to provide stability and support to the system 10. In the arrangement shown, as one example, the at least one center plate 38 is designed to prevent vertical and horizontal movement of the at least one rib 12. In this way, the at least one center plate 38 prevents the at least one rib 12 from moving vertically and horizontally by enclosing the at least one rib 12 in one, or more, of a plurality of positioning holes or slots 44. Additionally, in the arrangement shown, as one example, the center plate 38 is stabilized at each end by a partial rib 176. In the arrangement shown as one example, partial rib 176 extends from each end of the center plate 38 in an arcing manner where the partial rib 176 directly or indirectly through a horizontal plate 26, attaches to an end rod 50. In the arrangement shown, as one example, end rod 50 transfers any horizontal or vertical forces applied to the center plate 38 to the ground. The end rod 50 is further described herein.

In the arrangement shown, as one example, the at least one center plate 38 is designed to provide stability and support to system 10. In the arrangement shown, as is shown, the at least one center plate 38 is designed to prevent vertical and horizontal movement of the at least one rib 12. In this way, the at least one center plate 38 stabilizes the at least one rib 12 by creating a sturdy connection to the other at least one ribs 12 positioned on the same side, or on the opposing side of the containment area 66. In the arrangement, shown as one example, due to the shape of the at least one ribs 12, the arcing manner of the upper portion 20, creates an opposing force on the center plate 38 which stabilizes the structure horizontally and vertically.

In the arrangement shown, as one example, the center plate 38 extends a length from a first end 40 to a second end 42, having a partial rib 176 attached on each end. In this arrangement, as is shown, the center plate 38 extends in an approximate parallel spaced relation to the floor and to the at least one horizontal plate 26 for the entire length of the confinement crate system 10. However, other arrangements of center plate 38 are hereby contemplated for use.

In the arrangement shown, as one example, the at least one center plate 38 is located in the approximate top, middle of the confinement crate when viewed from an end elevation. However, the center plate 38 may be located at any point along the top of the confinement crate system or along the bottom. In the arrangement shown, as one example, the center plate 38 has a plurality of ribs 12 attached to the center plate 38, via positioning holes 44. In this arrangement, the center plate 38 is attached to ribs 12 spaced at equal distance along the length of center plate 38.

In the arrangement shown, as one example, the at least one center plate 38 is attached to other features of system 10 by welding. However, any other means for attachment are hereby contemplated for use without departing from the disclosure including, but not limited to, friction fitting, bolting, threading, gluing, and the like. Furthermore, in the arrangement shown, as one example, one center plate 38 is used in the design of the confinement crate system 10. However, any number of center plates 38 is hereby contemplated for use, including two, three, four, five, six, seven, eight, nine, ten, or more.

In the arrangement shown, as one example, the at least one center plate 38 is made from flattened or plated steel. However, any other material which is adequate for forming the at least one center plate 38 is hereby contemplated for use. Other materials include, but are not limited to, hollow tube, polymers, enhanced polymers, other metal materials, composites, or any combination thereof.

In an alternative embodiment, the at least one center plate 38 may be configured to connect and/or support multiple crate systems 10 arranged side by side, in either or both of a length and/or width arrangement. Additionally, at least one center plate 38 may be used as providing a connection and webbing for a plurality of crate systems 10.

Furthermore, as stated above, system 10 may comprise at least one center plate 38 wherein the center plate 38 has a plurality of positioning slots or holes 44 wherein the center plate 38 is configured to secure the at least one rib 12. Also, the center plate 38 may be configured to be secured to the at least one center plate 38 of an opposing assembly.

End Rod:

In the arrangement shown, as one example, confinement crate system 10 is used in association with at least one end rod 50. At least one end rod 50 may be formed of any suitable size, shape and design and is configured to stabilize each corner of the confinement crate 10. Additionally, in the arrangement shown, as one example, the at least one end rod 50 is configured to attach the main body of the confinement crate to the floor; the main body of the confinement crate being the at least one rib 12, the at least one horizontal plate 26, and the at least one center plate 38. In the arrangement shown, as one example, end rod 50 is configured to attach to the end of the horizontal plate 26 to provide support and stabilize the horizontal plate 26. Additionally, end rod 50 is configured to transfer any forces on the above main body of the confinement crate to the floor through the foot plate 56. Foot plate 56 is further described herein.

In the arrangement shown, as one example, end rod 50 is a continuous rod or wire which extends a length from a first end 52 to a second end 54. In the arrangement shown, as one example, end rod 50 is a circular rod or circular tube which is shaped in a straight fashion extending from the foot plate 56 to the top most horizontal plate 26.

In the arrangement shown, as one example, end rod 50 is generally a circular bar extending straight and perpendicular to the floor. In the arrangement shown, as one example, end rod 50 is approximately sized and designed with enough thickness for strength to house a full grown sow. Additionally, in the arrangement shown, as one example, end rod 50 is sized long enough to house a sow within a containment area 66. In the arrangement shown, as one example, the end rod 50, in addition to the partial rib 176, creates the height of the containment area 66, and accordingly the height of the confinement crate system 10. In the arrangement shown, as one example, the end rod 50 is a length adequate to comfortably house a full grown sow in the containment area 66. However, other lengths and thicknesses of end rod 50 are hereby contemplated for use. Other lengths and thicknesses may be necessary for housing larger or smaller livestock.

In the arrangement shown, as one example, end rod 50 is inserted or positioned through a plurality of positioning holes 32 of the at least one horizontal plate 26. In the arrangement shown, as one example, after end rod 50 is inserted in the positioning holes 32, end rod 50 is welded to the at least one horizontal plate 26. In the arrangement shown, as one example, the three horizontal plates 26 are spaced in an approximate equal spaced relation to one another along the vertical shaft that forms the end rod 50.

At the second end 54 of the end rod 50, or in the arrangement shown, as one example, the top end 54 of the end rod 50, the end rod 50 is attached to the upper most located horizontal plate 26. Additionally, and in the arrangement shown, as one example, the end rod 50 may be attached to the partial rib 176 at this end. In this way, the end rod 50 and horizontal plate 26 are perpendicular to one another. At the first end 52 of the end rod 50, or in the arrangement shown, as one example, the bottom end 52 of the end rod 50, the end rod 50 is attached to the foot plate 56. Foot plate 56, further described here, attaches the first end 52 of the end rod 50 to the floor of the confinement crate system 10.

In the arrangement shown, as one example, end rod 50 is stainless steel or steel to provide a robust resistance to the acidity of animal feces and urine. However, end rod 50 may be formed of any other material adequate to support the other components of confinement crate system 10. Any other material used for end rod 50 is hereby contemplated for use. Other materials include, but are not limited to rebar, hollow tube, polymers, enhanced polymers, other metal materials, composites, or any combination thereof.

Foot Plate:

In the arrangement shown, as one example, confinement crate system 10 is used in association with at least one foot plate 56. At least one foot plate 56 may be formed of any suitable size, shape and design and is configured to attach the first end 52 of the end rod 50 to the floor of the confinement crate system 10.

In the arrangement shown, as one example, foot plate 56 includes a top 58, a bottom 60, a first surface 62, and a second surface 64. In the arrangement shown, as one example, foot plate 56 is a generally flat, square piece of steel plate with tapered edges on the top two corners of the top 58 of the foot plate 56.

In the arrangement shown, as one example, foot plate 56 is sized to receive a portion of the first end 52 of the end rod 50 by welding a portion of the end rod 50 to the foot plate. In the arrangement shown, as one example, a portion of end rod 50 is welded to a first surface 62 of the foot plate 56, while the second surface 64 is welded to the floor beam assembly 124 or to at least one floor beam wherein floor beams comprise the floor beam assembly 124. Floor beam assembly 124 is further described herein. In this arrangement, as is shown, foot plate 56 is designed to attach the end rod 50, and thus the other components of system 10, to the floor.

In the arrangement shown, as one example, a foot plate 56 is located at the first end 52, and welded to the first end 52 of the end rod 50. In this arrangement, as is shown, each foot plate 56 is positioned at the bottom of system 10 so as to attach the components of system 10 to the floor.

In the arrangement shown, as one example, the at least one foot plate 56 is attached to the end rod 50 of system 10 by welding. Additionally, in the arrangement shown, the at least one foot plate 56 is attached to the floor. However, any other attachment means is hereby contemplated for use, including but not limited to, friction fitting, bolting, threading, gluing, and the like. Furthermore, in the arrangement shown, as one example, four foot plates 56 are used in the design of the confinement crate system 10. However, any number of foot plates 56 is hereby contemplated for use, including one foot plate 56, two foot plates 56, three foot plates 56, five foot plates 56, or more

In the arrangement shown, as one example, the at least one foot plate 56 is made from flattened, or plate steel. However, any other material which is adequate for forming the at least one foot plate 56 is hereby contemplated for use. Other materials include, but are not limited to, hollow tube, polymers, enhanced polymers, other metal materials, composites, or any combination thereof.

Furthermore, in one arrangement, as one example, the foot plate 56 is configured to rest upon and be secured to a building structure. In one arrangement, the building structure is comprised of a concrete building structure, but any type of building structure may be utilized without departing from the scope of the disclosure. Also, the foot plate 56 may be configured to connect to the floor beam assembly 124.

Containment Area:

In the arrangement shown, as one example, confinement crate system 10 is used in association with a containment area 66. Containment area 66 may be formed of any suitable size, shape and design and is configured to house livestock. In the arrangement shown, as one example, containment area 66 is formed by the components of system 10 which make up the main body of system 10; these components include the at least one rib 12, the at least one horizontal plate 26, the at least one center plate 38, the at least one end rod 50, among other components.

In the arrangement shown, as one example, the containment area 66 includes a rearward end 70 where a sow or other livestock enters the containment area 66. Additionally, in the arrangement shown, as one example, the containment area 66 includes a forward end 68 where the sow or livestock faces after entering the containment area 66. In the arrangement shown, as one example, the forward end 68 of the containment area 66 houses a feeder 130, such that the sow or other livestock may feed while standing in the containment area 66.

In the arrangement shown, as one example, containment area 66 is generally a rectangular space with an arced top surface formed by a plurality of upper portions 20 of the at least one ribs 12 extending above the containment area 66. In the arrangement shown, as one example, containment area 66 is shaped to house a sow in a manner which a full grown sow cannot turn around in the containment area 66. In the arrangement shown, as one example, containment area 66 is shaped and sized so a sow can stand up and lay down. However, other shapes and sizes are hereby contemplated for use, including shapes and sizes for various livestock, and for various quantities of livestock.

Door(s):

In the arrangement shown, as one example, confinement crate system 10 is used in association with a first door 76, also known as a rear door 76. In the arrangement shown, as one example, confinement crate system 10 is used in association with a second door 98, also known as a front door 98. In the arrangement shown, as one example, confinement crate system 10 is used in association with a supplemental door 86, also known as a butt door 86.

First Door: First door 76 may be formed of any suitable size, shape and design and is configured to provide an entrance for livestock to enter the containment area 66 of the system 10. In the arrangement shown, as one example, first door 76 includes a panel 78, eyes 80, drop rod 82, and wire components 84.

In the arrangement shown, as one example, first door 76 is formed mainly of at least one panel 78. In the arrangement shown, as one example, panel 78 is generally flat and rectangular and is configured to provide an enclosure to keep livestock from escaping the containment area 66 or to keep unwanted livestock from entering the containment area 66.

In the arrangement shown, as one example, panel 78 includes wire components 84 which form a pair of eyes 80 extending laterally from the panel 78 on each side. In the arrangement shown, as one example, eyes 80 are small circular loops extending from the panel 78 and are configured to receive a drop rod 82 therein. In this way, a drop rod 82 can be dropped through a combination of the eyes 80 and the positioning holes 32 of the horizontal plate 26, so that a panel 78 is connected to the main structure of system 10 via a hinge. In this way a first door 76 is formed.

In the arrangement shown, as one example, the panel 78 includes a pair of eyes 80 on the opposite side of the panel 78 to the first set of eyes 80. In the arrangement shown, as one example, a second drop rod 82 is used on the opposite side to open and close the panel 78. Thus, in the arrangement shown, as one example, the first door 76 can be opened or closed on either side of the panel 78.

In the arrangement shown, first door 76 is sized, shaped, and designed to enclose an end of the main structure of system 10. Thus, in the arrangement shown, as one example, first door 76 forms an enclosure, capable of opening and closing the containment area 66.

In the arrangement shown, as one example, the first door 76 is made from steel panels and/or stainless steel rods and wire. However, any other material which is adequate for forming the first door 76 is hereby contemplated for use without departing from the disclosure. Other materials include, but are not limited to, rebar, hollow tube, polymers, enhanced polymers, other metal materials, composites, or any combination thereof.

Second Door: Second door 98 may be formed of any suitable size, shape and design and is configured to provide an exit opening as well as feed the livestock within the containment area 66. In the arrangement shown, as one example, the second door 98 is configured similarly to the first door 76. In the arrangement shown, as one example, second door 98 is identical to the first door 76 and functions in a similar fashion as first door 76. In the arrangement shown, as one example, second door 98 may be formed of a primary panel 100, or may be formed primarily of a feeder 130. However, second door 98 is located on the opposite side of the system 10 as first door 76.

In an alternative embodiment, second door 98 includes a feeder 130. Feeder 130 is further described herein. In this arrangement, the second door 98 not only is configured to enclose the livestock in the containment area 66, but the second door 98 is configured to provide food and water to the livestock in the containment area 66.

In the arrangement shown, as one example, the second door 98 is made from steel panels and/or stainless steel rods and wire. However, any other material which is adequate for forming the second door 98 is hereby contemplated for use. Other materials include, but are not limited to, rebar, hollow tube, polymers, enhanced polymers, other metal materials, composites, or any combination thereof.

Supplemental Door: Supplemental door 86 may be formed of any suitable size, shape and design and is configured to force a sow or other livestock forward and provide a secure passage area for piglets to travel between safety areas 114 behind the containment area 66. Sows and other livestock come in varying shapes and sizes. Some sows are longer than others from nose to rear. In the arrangement shown, as one example, the supplemental door 86 is adjustable and able to be relocated along the length of the horizontal plates 26. Thus, in the arrangement shown, as one example, supplemental door 86 is configured to provide an enclosure at varying points along the length of system 10 so as to position varying sizes of livestock forward in the containment area 66.

In the arrangement shown, as one example, supplemental door 86 includes at least one upper horizontal bar 88, at least one lower horizontal bar 90, at least one pivot bar 92, at least one drop rod 94, and at least one set of eyes 96.

In the arrangement shown, as one example, the supplemental doors 86 are not only configured to position a livestock to the front of the containment area 66, but the supplemental doors 86 are also configured to pivot fully into and out of the containment area 66 to allow loading sow into crate. Horizontal doors eliminate the need for operators to lift doors.

In the arrangement shown, as one example, supplemental doors 86 are shaped as two separate doors, one on each side of the main body of the containment area 66. In the arrangement shown, the two separate doors which form the supplemental doors 86 are attached at equal points along the distance of at least one horizontal plate 26.

In the arrangement shown, as one example, the supplemental door 86 is formed of bars shaped to extend approximately halfway into the center of the containment area 66. In the arrangements shown, as one example, the upper horizontal bars 88 and the lower horizontal bars 90 are positioned within the containment area 66 with the ability to pivot directly out of the containment area 66 by removing the drop rods 94 which secure the bars 88/90 to the horizontal plates 26. Furthermore, in the arrangement shown, as one example, the pivot bars 92 in conjunction with a drop rod 94 create a rotation which allows the door-like features of the supplemental door 86 to rotate into and out of the containment area 66. This solution, as is shown in the example, allows the supplemental door 86 to swing out into the safety area 114, or piglet area, without interfering with the piglets. The safety area 114 is further described herein.

Said another way, in the arrangement shown, as one example, the supplemental doors 86 are attached to the horizontal plates 26. The set of eyes 96 of the pivot bars 92 are held in place by a drop rod 94 placed through the eyes 96 of the pivot bars 92 and the positioning holes 32 of the horizontal plates. In this arrangement, as is shown in one example, the same type of drop rod 94 is used for the doors portion of the supplemental door 86. In this arrangement, as is shown in an example, the drop rod 94 of the doors portion passes through the eyes 96 of the upper horizontal bars 88 and the lower horizontal bars 90, which form the doors portion of the supplemental door 86.

In this arrangement, as is shown, in one example, when the supplemental door 86 is in the closed position, a second drop rod 94 contains the door portions of the supplemental door 86 by passing through the horizontal plates 26 and the eyes 96 of the upper horizontal bars 88 and the lower horizontal bars 90. In this arrangement, as is shown in one example, the supplemental door 86 assembly can be moved forward and backward along the length of the horizontal plates 26 based on the position of the drop rods 94 through the eyes 96 and the pivot bars 92.

In the arrangement shown, as one example, the supplemental door 86 also has a set of eyes 96 for securing the supplemental door 86 in the open position. In this arrangement, the drop rod 94 passes through the horizontal plates 26 and through an eye 96 located on the interior part of the door portion of the supplemental door 86. In this arrangement, negative interactions with the sow are avoided because the supplemental door 86 is completely, or almost completely, removed from the containment area 66.

In the arrangement shown, as one example, the depth and height of the supplemental door 86 is set for the size of an adult, nursing sow. However, additional depth and height can be added to the supplemental door 86 to meet various livestock size requirements. In the arrangement shown, as one example, installation of the supplemental door 86 requires no tools, small parts, or fasteners of any kind.

In the arrangement shown, as one example, the supplemental door 86 is made from steel or stainless steel rods. However, any other material which is adequate for forming the supplemental door 86 is hereby contemplated for use without departing from the disclosure. Other materials include, but are not limited to, rebar, hollow tube, polymers, enhanced polymers, other metal materials, composites, or any combination thereof.

Other Features:

Feeder: In the arrangement shown, as one example, confinement crate system 10 is used in association with a feeder 130. Feeder 130 may be formed of any suitable size, shape and design and is configured to feed livestock in the containment area 66.

In the arrangement shown, as one example, feeder 130 includes a top 132, a bottom 134, sidewalls 136, an interior surface 138, an exterior surface 140, forming a trough 142 for feeding livestock, and may include a feed tube 144. Additionally, the feeder 130 may include fins 146 for rotating the feeder 130 about a vertical access for cleaning and the like. In the arrangement shown, as one example, the feeder 130 is sized, shaped, and designed to allow a sow and other livestock to consume feed being held in the trough 142 of the feeder 130.

In the arrangement shown, as one example, feeder 130 is located and forms the panel portion of the second door 98. In this way, the feeder 130 is at the front of the system 10. As is shown in one example, the sow or other livestock in the containment area 66 is able to feed from the feeder 130 while standing in the containment area 66.

In the arrangement shown, as one example, feeder 130 is formed of a steel or polymer created in a deep-drawning process to create a common shell, a process similar to kitchen sink. The two sides of the feeder 130 that are stamped are then fabricated together. However, any other material, process, or method for feeding livestock is hereby contemplated for use without departing from the disclosure. Other materials include, but are not limited to, metal, polymers, enhanced polymers, other metal materials, composites, or any combination thereof.

Safety Area: In the arrangement shown, as one example, confinement crate system 10 is used in association with a safety area 114. Safety area 114 may be formed of any suitable size, shape and design and is configured to provide an area of refuge for piglets to escape the immediate presence of the sow. In the arrangement shown, as one example, two safety areas 114, also referred to as piglet areas, are located adjacent to the containment area 66. In the arrangement shown, as one example, a safety area 114 is an area that the adult livestock within the containment area 66 cannot move to. In the arrangement shown, as one example, only a piglet or a much smaller livestock can pass through the lower portion 24 of the at least one rib 12. Thus, in this arrangement, a safety area 114 for the piglets is created.

In the arrangement shown, as one example, safety area 114 is formed by a safety floor 116 which includes at least one floor panel 118. Furthermore, in the arrangement shown, as one example, the floor panel 118 and/or safety area 114 includes holes 120 and nursery panels 122.

In the arrangement shown, as one example, the safety area 114 is a rectangular, flat shape which is adjacent to and relatively level with the containment area 66 and containment floor 108. In the arrangement shown, as one example, the safety area 114 is large enough to house an entire litter of piglets such that the piglets can escape the containment area 66. In the arrangement shown, as one example, the safety area 114 is designed as a bio-secure area where piglets can safely nurse.

In the arrangement shown, as one example, the safety area 114 is formed of a safety floor 116 which comprises safety floor panels 118 with holes 120. In this arrangement, the holes 120 allow bio-waste to pass through the floor panels 118 and into a contaminant pit 72. In the arrangement shown, as one example, the safety area 114 is surrounded along three sides by guards 122. Guards 122 are formed of any suitable size, shape, and design and are configured to contain the litter of piglets within the safety area 114. In the arrangement shown, as one example, the guards 122 form three sides of the safety area 114 while the fourth side abuts the containment area 66.

Floor Assembly: In the arrangement shown, as one example, confinement crate system 10 is used in association with a floor assembly 124. The floor assembly 124 may also be referred to as a floor deck assembly 124 throughout the disclosure. Floor assembly 124 may also be referred to as floor beam assembly 124 without departing from the disclosure. Floor assembly 124 may be formed of any suitable size, shape, and design and is configured to provide an improved biosecurity floor strong enough to support large livestock. In other words, the floor assembly 124 is configured to provide adequate strength and durability to withstand repeated treading and movement by heavy objects applying various pressure loads across varying load points of the floor. Additionally, the floor assembly 124 is configured to provide biosecurity.

In the arrangement shown, as one example, is a floor assembly 124 configured to provide a confinement system 10 that supports direct flow of bio-waste into a holding tank or transmission system below the floor. This system is important to biosecurity. In this way, in this arrangement, a bio-secure floor assembly 124 is presented that prevents buildup of contaminants in underside spaces and cleans easily between nursing sows.

In the arrangement shown, as one example, the floor assembly 124 includes beams 126 and stiffeners 128. In the arrangement shown, as one example, various types of floor panels 110/118 are configured depending upon the position of the system 10. In the containment area 66, a containment floor 108 is used in association with containment floor panels 110 having holes 112 that are configured to overlap and interlock with the safety floor panels 118 of the safety floor 116 used in the safety area 114.

In one arrangement, as an example, the floor assembly 124 comprises a plurality of floor beams and a plurality of stiffeners. In one arrangement, the plurality of floor beams (as described below) are secured to the foot plate which is secured to an end rod. Additionally, the floor beam may be secured to a foot plate. In one arrangement, as an example, the floor beams are stiffened with interlocking stiffener struts. Also, the floor beams interlock with the safety and containment floor panels 110/118.

Beams: In the arrangement shown, as one example, the structure of the floor assembly 124 is used in association with at least one beam 126. Beam 126 is formed of any suitable size, shape, and design and is configured to provide support for the floor panels 110/118. In one arrangement, the plurality of beams 126 are made of a corrosion resistant material. However, the plurality of beams 126 may be made of any type of material without departing from the scope of the disclosure. Furthermore, the beams 126 can be utilized in mix material combinations to meet different floor assembly 124 load requirements. In the arrangement shown, as one example, beams 126 are a generally flat, rectangular bar turned on its slender side to maximize vertical loading strength. In the arrangement shown, as one example, beams 126 extend the length of system 10 from one foot plate 56 at one end of the system 10 to a foot plate 56 at the opposite end. In the arrangement shown, as one example, beams 126 are notched at each end of the length of the beam 126, to interlock with the notched foot plates 56 attached to the end rods 50.

In the arrangement shown, as one example, beams 126 are made of stainless steel. Stainless steel is a material that can handle long-term exposure to animal feces and urine and prevent structural failure. However, beams 126 could be formed of other materials. Other materials include, but are not limited to, polymers, fiberglass, steel, aluminum, enhanced polymers, polymer composites, and the like.

Stiffeners: In the arrangement shown, as one example, beams 126 are used in conjunction with stiffeners 128. Stiffeners 128 are formed of any suitable size, shape and design and are configured to stiffen the beams, adding strength to the floor assembly 124. In the arrangement shown, as one example, stiffeners 128 are used with beams 126 to form a grid-like pattern of supports for the floor panels 110/118. In the arrangement shown, stiffeners 128 are formed of a generally flat, rectangular stainless steel bar connected to the sidewall of a beam 126 on each end of the stiffener 128. In the arrangement shown, as one example, stiffeners 128 are also configured to connect to the foot plates 56 for added supports on the end. In the arrangement shown, this grid-like pattern prevents flexing in the system 10 both during assembly of the system 10 and during use.

Furthermore, in the arrangement shown, as one example, the final structural integrity of the floor assembly 124 design is complete when the floor panels 110/118 are interlocked with the beams 126 and/or stiffeners 128. In this way, as is shown in one example, the stiffeners 128 may be light and may not be required due to the stabilizing, interlocking features of the floor panels 110/118.

In the arrangement shown, as one example, the stiffeners 128 are notched at each end. The notches of the stiffeners 128 enable the stiffeners 128 to be attached to the beams 126 by interlocking. In this way, installation disassembly is quick, efficient, and requires no tools.

In the arrangement shown, as one example, stiffeners 128 are made of stainless steel. However, stiffeners 128 could be formed of any other material without departing from the disclosure. Other materials include, but are not limited to, polymers, fiberglass, steel, aluminum, enhanced polymers, polymer composites, and the like.

Bio-secure Floor Assembly:

In the arrangement shown, as one example, floor assembly 124 includes two types of bio-secure floor panels 110/118. In the arrangement shown, as one example, the containment floor 108, which houses the sow or livestock, uses a containment floor panel 110 with holes 112 which is designed to overlap and interlock with the safety area 114 floor panels 116. In the arrangement shown, as one example, the safety area 114 is configured with floor panels 118 which have holes 120. Additionally, the safety area 114 is enclosed by nursery panels 122.

In the arrangement shown, as one example, the interlocking floor panels 110/118 are configured to provide strength and easy assembly. Additionally, the floor panels 110/118 are configured with a geometry which allows for contaminant passage. Additionally, in the arrangement shown, as one example, the floor panels 110/118 are configured with slots which allow for interconnecting to other floor panels 110/118. Additionally, floor panels 110/118 are configured with slots which allow for easy connection to nursery panels 122. Additionally, floor panels 110/118 are configured with notches to allow for easy connection to beams 126, sitting on top of and interlocking with beams so as to form a generally flat floor.

In the arrangement shown, as one example, floor panels 110/118 are molded plastic or polymer. In this way, injection molding is used to create a cost-effective, high volume solution to floor panel 110/118 production. Additionally, in the arrangement shown as one example, the floor panels 110/118 are a dark color which allows the floor panels 110/118 to retain heat energy for the piglets or other livestock. Additionally, the floor panels 110/118 are made of a material that prevents bacteria build-up. Furthermore, the floor panels 110/118 are easy to clean due to the material they are made of In this way, with the addition of easy contaminant pass-through, a safer bio-secure floor is created in association with an efficient clean-out system located below the floor panels 110/118.

In one arrangement, as one example, floor assembly 124 comprises a plurality of floor panels including, but not limited to, safety floor panels 118 and containment floor panels 110. Throughout the disclosure, the safety floor panels 118 may be referred to as offspring floor panels 118 or safety area floor panels 118 and the containment floor panels 110 may be referred to as sow floor panels 110 without departing from the disclosure. Sow floor panels 110 provide support for at least one adult animal and offspring floor panels 118 provide support for at least one offspring which is generally the offspring of the adult animal. In one arrangement, as an example, the sow floor panels 110 are cast steel. However, any other type of material may be utilized to form the sow floor panels 110 without departing from the scope of the disclosure. Additionally, the sow floor panels 110, in one arrangement, are formed of steel plating. However, any other type or method of formation may be utilized without departing from the scope of the disclosure. The offspring floor panels 118 are generally not metallic and are made of heat absorbing material. However, any other type of material or method for forming the offspring floor panels 118 may be utilized without departing from the disclosure. The offspring floor panels 118 may also comprise holes or slots to receive partitioning panels and may comprise an offspring panel locking mechanism in order to secure the panels. Also, it should be noted that the offspring floor panels 118 are not position dependent and may be moved as needed.

Interlocking Tabs: In the arrangement shown, confinement crate system 10 is used in association with a plurality of interlocking tabs 164. It should be noted that the interlocking tabs 164 may also be referred to as tabs 164 without departing from the disclosure. Interlocking tabs 164 may be used in assembly for added stabilization, however, interlocking tabs 164 are not required. Interlocking tabs 164 may be formed of any suitable size, shape, and design and are configured to attach the floor panels 110/118 to one another as well as stabilize and attach floor panels 110/118 to the floor assembly 124. In this arrangement, as is shown in one example, the plurality of interlocking tabs 164 can be seen extending from the bottom surface of the containment floor panels 110. In this way, interlocking tabs 164 are a part of the floor panels 110. However, other variations and configurations of tabs 164 for connecting and interlocking floor panels 110/118 are hereby contemplated for use.

Containment Pit: In the arrangement shown, as one example, confinement crate system 10 is used in association with a containment pit 72. It should be noted that the containment pit 72 may also be referred to as a contaminant pit 72 or a bio-waste containment pit 72 without departing from the disclosure. Containment pit 72 may be formed of any suitable size, shape and design and is configured to provide a means of easy clean out of feces and urine after they have fallen from the system above. In the arrangement shown, as one example, containment pit 72 is a large opening located below the floor assembly 124 where feces and urine can fall and then be washed out.

In the arrangement shown, as one example, the containment pit 72 is a generally rectangular opening. In the arrangement shown, as one example, containment pit 72 includes a lip 74. The lip 74 may also be referred to as a shelf 74 without departing from the disclosure. Lip 74 is formed of any suitable size, shape and design and is configured to provide an attachment means of the floor assembly 124. In this arrangement, as is shown, lip 74 allows the floor assembly 124 to be set lower than the level of the floor of the surrounding area such that no steps are required to enter the containment area 66. In this way, the lip 74 lowers the entire system 10 so that the containment floor 108 and the safety floor 116 are level with the surrounding, environment floor.

Water Tree: In the arrangement shown, as one example, confinement crate system 10 is used in association with a water tree 148. Water tree 148 may be formed of any suitable size, shape and design and is configured to provide potable water to livestock and other animals housed within system 10. In other words, in the arrangement shown, as one example, the water tree 148 is an assembly of pipe components that supply water to the sow and the piglets.

In the arrangement shown, as one example, water tree 148 includes a pipe 150, a notch 152, a tree retention wire 154, and a position form wire 156. In this arrangement, as is shown, the water tree 148 is represented by a singular, vertical pipe 150. In the arrangement shown, as one example, the vertical pipe 150 is integrated into the horizontal plates 26 by at least one notch 152. The at least one notch 152 is a small notch or cut into the horizontal plates 26, which creates a place for the pipe 150 to be placed into the side of the horizontal plates 26.

In the arrangement shown, as one example, the pipe 150 is secured into the at least one notch 152 by a tree retention wire 154. Tree retention wire 154 is configured to attach to positioning holes 32 on each end of the wire and secure the water tree pipe 150 in place in the notch 152. Furthermore, to keep the pipe 150 from spinning or moving vertically in the notches 152, a position form wire 156 is used.

In the arrangement shown, as one example, position form wire 156 is configured as a wire bent in simultaneous ‘S’ shapes. In this way, the position form wire 156, which is attached to the pipe 150, can interlock with the horizontal plates 26. Thus, vertical movement and spinning of the pipe 150 are prevented. In the arrangement shown, as one example, reduction in vertical and other movements of water tree 148 can be important considering the size of the animal interacting with the water tree 148.

These and other configurations and materials for a water supply to livestock are hereby contemplated for use. Additionally, the water tree retention wire 154 could have many shapes, sizes, and designs, but some advantages of the design shown in the example herein, are that installation requires no tools and is bio-security safe. Furthermore, while one water tree 148 is shown in the example, any number of water trees 148 may be installed in system 10.

Heat Lamp: In the arrangement shown, as one example, confinement crate system 10 is used in association with a heat lamp 158. Heat lamp 158 may be formed of any suitable size, shape, and design and is configured to provide heat to livestock or others housed within system 10. In the arrangement shown, as one example, a formed wire or heat lamp rod 160 operably connects to the heat lamp 158 and connects the heat lamp 158 to the horizontal plates 26. In the arrangement shown, as one example, the heat lamp rods 160 operably connect to the horizontal plates 26 by being inserted into the positioning holes 32 of the horizontal plates 26.

In the arrangement shown, as one example, the horizontal plates 26 support the heat lamp rods 160, and in turn the heat lamp 158. In the arrangement shown, as one example, the heat lamp rod 160 is a continuous wire extending from a first end to a second end. In this configuration, as is shown, the heat lamp rod 160 is bended and formed so it can be inserted and/or operably connected to the heat lamp 158 by a hook 162 of the heat lamp rod 160. In this arrangement, as is shown, the heat lamp 158 is suspended from this hook 162.

In the arrangement shown, as one example, the continuous wire or heat lamp rod 160 is a single wire. However, the continuous wire could be a weldment consisting of a tab that bolts to a positioning hole 32 of the horizontal plate 26 and/or the center plate 38. In another arrangement, the continuous wire or heat lamp rod 160 could be formed as a tension or compression spring that clamps between multiple components of system 10, such as the at least one rib 12 and a horizontal plate 26.

In the arrangement shown, as one example, the heat lamp rod 160 is formed using a high production CNC wire former and is formed of metal. This design is bio-secure. However, other materials, shapes, and sizes are hereby contemplated for use. Other materials include, but are not limited to, polymers, fiberglass, steel, aluminum, enhanced polymers, polymer composites, and the like. Additionally, a simple heat light mount is used for a heat lamp 158, however any other configuration, type, or number of heat lamps 158 is hereby contemplated for use.

Sensor: In the arrangement shown, as one example, system 10 may be use in association with at least one sensor 166. Sensor 166 may be formed of any suitable size, shape and design and is configured to detect environmental conditions of system 10. Furthermore, sensors 166 may be joined with other components which help relay that information to a controller or other device, such as a programmable logic controller. Any number of sensors 166 may be utilized by system 10 to detect any number of variables. For example, the system 10 may comprise one, two, three, four, five, six, seven, eight, nine, ten, or more sensors 166. Some sensor 166 types may include, but are not limited to, force sensors, pressure sensors, motion sensors, temperature sensors, reflex sensors, water level sensors, food level sensors, heart rate sensors, positioning sensors, weight sensors, contaminant detection and monitoring sensors, containment pit level sensors, and more. Furthermore, sensor 166 may be used in conjunction with a hardware management system 168.

Hardware Management: In the arrangement shown, as one example, confinement crate system 10 is used in association with a hardware management system 168. Hardware management system 168 may be formed of any suitable size, shape and design and is configured to assist a user and/or automatically control environmental conditions and/or variables of system 10. Furthermore, hardware management system 168 may include an application 170 which is run by a user, potentially a user accessing a mobile device and/or other computer and/or other programmable logic controller.

Installation:

In the arrangement shown, as one example, confinement crate system 10 is easy to install and provides novel installation features which solve long-standing needs in the art. In the arrangement shown, as one example, installation of system 10 in a barn requires only five to seven bolts, making installation the simplest in the industry. In the arrangement shown, as one example, all other components or optional components of system 10 merely drop-in and/or are retained with clips requiring no tools for assembly. Other components of system 10 are doors, heat lamps 158, water trees 148, feeders 130, among other components.

In the arrangement shown, as one example, modern high volume manufacturing is used to minimize parts count and welded joints while maximizing part functionality and reducing and/or eliminating direct labor cost during manufacturing, installation and utilization. In the arrangement shown, as one example, manufacturing methods include, but are not limited to, CNC wire bending, die stamping, progressive die stamping, die forming, wire straightening, CNC laser cutting, injection molding, automatic sand casting, and robotic welding, among other automated systems. In the arrangement shown, as one example, high functional value is engineered into every component of system 10. In the arrangement shown, as one example, high engineering value is optimized for strength and minimization of the weight of every component of system 10. In the arrangement shown, as one example, cost is greatly reduced by engineering, installation and assembly methods described herein.

In Operation:

In the arrangement shown, as one example, once system 10 is assembled, either one of two drop rods 82 of the first door 76 can be removed. Removal of a drop rod 82 of the first door 76 will allow the door to open via a second hingedly connected drop rod 82. Similarly, the drop rods 94 of the supplemental doors 86 can be lifted out of the eyes 96 of the supplemental doors 86 so that the supplemental doors 86 can pivot out of the containment area 66. The doors can be open either direction to facilitate animal movement in and out of the confinement.

Once the first door 76 is opened and the supplemental door 86 is cleared from the containment area 66, livestock can enter the containment area 66. Once the livestock is in the containment area 66, the drop rod 82 of the first door 76 can be reinserted such that the first door 76 is closed. Second, the supplemental doors 86, or butt doors 86, can be reengaged to force the livestock to a forward position in the containment area 66, if desired.

Once secured in the containment area 66, livestock are able to feed from the feeder 130 and/or drink from the water tree 148. Livestock are also potentially warmed by the heat lamp 158. The system conditions can be monitored from a hardware management system 168 if installed.

Furthermore, in the arrangement shown, as one example, a litter of piglets could be added to the safety area 114 if desired. In this arrangement, as one example, piglets in a safety area 114 would have access to a sow in the containment area 66. In this arrangement, piglets could nurse but still have a means of escape to the safety area 114 if the sow shifts or decides to lie down in the containment area 66. Furthermore, a heat lamp 158 and water tree 148 could be arranged for the piglets in the safety area 114. Additionally, nursery panels 122 can be clipped into place along the perimeter of the safety area 114 to contain the piglets.

In the arrangement shown, as one example, when it is desired for the sow or livestock to be removed from the containment area 66, a drop rod 104 of the second door 98 is merely lifted out of the eyes 102 and/or out the wire components 106 forming the eyes, such that an operable door is created. The sow or other livestock can walk straight forward out of the containment area 66.

In the arrangement shown, as one example, when the sow or other livestock are housed within the containment area 66, waste or feces and urine are created. The feces and urine will fall through holes 112/120 of the bio-secure floor 108/116 and into a containment pit 72. The containment pit 72 can be flushed out at any time desired to keep feces and urine from compiling and away from the sow, piglets, and/or other livestock. This bio-secure floor prevents feces and urine from accruing in the containment area 66 and/or in the safety area 114. Additionally, the bio-secure floor prevents feces and urine from building up on the underside of the panels 110/118.

From the above it will be appreciated that the confinement crate system 10 provides the following: a bio-secure crate wherein bio-secure means reducing the potential to retain biological elements such as animal waste which host diseases; is easily cleaned which increases bio-security; utilizes three-dimensional geometries to improve structural integrity of the crate; allows for a sow to stand or lay down without causing injury or death to the piglets caught between the sow and crate structural members; resists dislodging and deformation due to sow pushing, lifting, or gnawing on the structure; resists dislodging and deformation due to body weight and rubbing forces; provides some flex in the system to accommodate the pushing created by the animals without impacting the long-term structure and/or structural integrity of the system; constrains hos and/or other livestock in a singular and/or plural orientation; limits the hogs vertical motion preventing injury to hog or staff members; allows for proper ventilation; allows for vertical discharge of waste to the pit without potential for entrapment; does not damage sow teats; reduces assembly tools required and/or eliminates the need for assembly tools for onsite assembly or disassembly; utilizes manufacture systems for high production and/or automated processes; optimizes the production cost to primarily materials and equipment depreciation; optimizes or eliminates labor cost; reduces the per crate shipping weight; provides an engineered solution that includes an integrated floor structure; reduces assembly stack up error associated with welding; minimizes the total unique part count per assembly; minimizes tools required for assembly; minimizes raw material geometric shapes; illustrates a farrowing crate; illustrates an assembly of farrowing crates in a barn; illustrates assembly and integration of a plurality of farrowing crates; illustrates assembly and integration and interlocking of a plurality of farrowing crates in a barn; among countless other advantages and improvements.

It will be appreciated by those skilled in the art that other various modifications could be made to the system without parting from the spirit and scope of this disclosure. All such modifications and changes fall within the scope of the disclosure and the claims and are intended to be covered thereby.

What is claimed:

1. A livestock confinement crate system, comprising:
At least one rib wherein each of the at least one rib comprises an upper portion, a middle portion, and a lower portion;
Wherein each of the at least one rib extends a length from a first end to a second end;
At least one horizontal plate wherein each of the at least one horizontal plate extends a length from a first end to a second end;
Wherein each of the at least one horizontal plate has a plurality of positioning slots;
Wherein the at least one horizontal plate is connected to the at least one rib;
At least one end rod wherein each of the at least one end rod extends a length from a first end to a second end;
Wherein the at least one end rod is connected to the first end of the at least one horizontal plate;
Wherein the at least one rib, the at least one horizontal plate, and the at least one end rod are configured to create at least one confinement side assembly.

2. The system of claim 1 comprising:
two confinement side assemblies;
wherein the two confinement side assemblies are opposingly combined to confine an animal while allowing offspring of the animal to access the animal.

3. The system of claim 1, wherein the at least one rib is continuous.

4. The system of claim 1, wherein the at least one rib has a solid sectional profile.

5. The system of claim 1, wherein the at least one rib has a solid sectional profile and is not formed from a stand commodity material shape.

6. The system of claim 1, wherein the at least one rib has a solid sectional profile which is a casting.

7. The system of claim 1, wherein the at least one rib has a solid sectional profile which is injected molded.

8. The system of claim 1, wherein the at least one rib as an inner and an outer sectional profile.

9. The system of claim 1, wherein the lower portion of the at least one rib is a Flying-W.

10. The system of claim 1, wherein the lower portion of the at least one rib includes components of the Flying-W in multiple planes.

11. The system of claim 1, wherein the lower portion of the at least one rib includes components of the Flying-W welded to opposing and parallel surfaces of the at least one horizontal plate.

12. The system of claim 1 wherein the at least one horizontal plate comprises two horizontal plates and wherein the lower portion of the at least one rib includes components of the Flying-W welded to opposing and parallel surfaces of the at least two horizontal plates.

13. The system of claim 1, further comprising:
At least one center plate;
Wherein the center plate has a plurality of positioning slots; and
Wherein the at least one center plate is configured to secure the at least one rib;
Wherein the at least one center plate is configured to be secured to the at least one center plate of an opposing assembly.

14. The system of claim 1, further comprising:
A first door;
A second door;
A containment area;
Wherein the second door is configured to provide an exit opening thereby allowing an animal to enter the containment area through the first door and exit the containment area through the second door.

15. The system of claim 14 further comprising a supplemental door, wherein the supplemental door is configured to position the animal at the forward end of the containment area.

16. The system of claim 1 further comprising:
A floor assembly;
Wherein the floor assembly comprises a plurality of floor panels;
Wherein each floor panel comprises holes configured to allow air to pass through the holes.

17. The system of claim 16 further comprising:
A foot plate;
Wherein the foot plate is configured to connect the at least one end rod to the floor assembly.

18. The system of claim 16 further comprising:
a foot plate;
wherein the foot plate is configured to connect the at least one end rod to the floor assembly;
wherein the foot plate is configured to rest on a concrete building structure;
wherein the foot plate is configured to be secured to the concrete building structure;
wherein the foot plate is configured to connect to the floor beam assembly.

19. The system of claim 16, wherein the floor assembly further comprises:
a plurality of floor beams and a plurality of stiffeners;
wherein the plurality of floor beams are secured to the foot plate which is secured to an end rod;
wherein the plurality of floor beams are secured to a foot plate;
wherein the plurality of floor beams are stiffened with interlocking stiffener struts;
wherein the plurality of floor beams interlock with the floor panels.

20. The system of claim 1 further comprising:
A safety area;
A containment area;
Wherein the safety area is positioned adjacent the containment area;
Wherein the safety area is configured to house offspring of an animal.

21. The system of claim 1 further comprising:
A containment pit;
A containment area;
A floor assembly;
Wherein the containment pit is positioned below the containment area such that contaminants pass through the floor assembly into the containment pit.

22. The system of claim 1 further comprising:
A floor assembly wherein the floor assembly is comprised of a plurality of floor beams and a plurality of stiffeners.

23. The system of claim 1 further comprising:
A feeder;
A containment area;
Wherein the feeder is positioned at the forward end of the containment area such that the feeder is configured to supply feed to an animal confined in the containment area.

24. The system of claim 1 further comprising:
A water tree;
A containment area;
Wherein the water tree is configured to supply water to an animal confined within the containment area.

25. The system of claim 1 further comprising:
A water tree;
A containment area;
Wherein the water tree is configured to supply water to a plurality of animals located in an adjoining safety area.

26. The system of claim 1 further comprising:
A floor assembly;
A plurality of tabs configured to secure the containment crate system to the floor assembly.

27. The system of claim 1 further comprising:
At least one sensor configured to detect at least one environmental condition of the confinement crate system.

28. The system of claim 1 further comprising:
A hardware management system configured to respond to a data input and cause an output.

29. The system of claim 1 further comprising:
An application;
Wherein the application is installed on an electronic device and controlled via a user interface;
Wherein the application is wirelessly connected to a hardware management system and configured to wirelessly control the hardware management system.

30. The system of claim 1 further comprising:
a floor assembly;
wherein the floor assembly comprises a plurality of floor panels;
wherein the floor panels consist of sow floor panels and offspring floor panels;
wherein the sow floor panels support at least one adult animal;
wherein the offspring floor panels support at least one offspring of the at least one adult animal;
wherein the sow panels rest on top of the offspring floor panels;
wherein the sow panels interlock with the offspring panels and floor beams;
wherein the offspring panels interlock with adjacent offspring panels;
wherein the offspring panels interlock with the floor beams;
wherein the offspring panels have slots to receive the partitioning panels;
wherein each floor panel comprises holes configured to allow air, feces, and urine to pass through the holes.

31. A livestock confinement crate system, comprising:
At least one rib;
Wherein each of the at least one rib comprises an upper portion, a middle portion, and a lower portion;
Wherein each of the at least one rib extends a length from a first end to a second end;
At least one horizontal plate;
Wherein each of the at least one horizontal plate extends a length from a first end to a second end;
Wherein each of the at least one horizontal plate has a plurality of positioning holes;
Wherein each of the at least one horizontal plate is connected to the at least one rib;
At least one end rod;
Wherein the at least one end rod extends a length from a first end to a second end;
Wherein the at least one end rod is connected to the first end of the at least one horizontal plate;
A first door;
Wherein the first door has a panel and the panel is configured to contain an animal within the containment crate system;
Wherein the first door has a plurality of eyes;
Wherein the first door has a drop rod;
Wherein the plurality of eyes are configured to receive the drop rod thereby operatively connecting the first door to the at least one horizontal plate.

32. A livestock confinement crate system, comprising:
at least one rib;
the at least one rib each having an upper portion, a middle portion, and a lower portion;
the at least one rib each extending a length from a first end to a second end;
at least one horizontal plate;
the at least one horizontal plate extending a length from a first end to a second end;
the at least one horizontal plate having a plurality of positioning holes;
wherein the at least one horizontal plate is connected to the at least one rib;
at least one end rod;
the at least one end rod extending a length from a first end to a second end;
wherein the at least one end rod is connected to the first end of the at least one horizontal plate;
a first door;
the first door having a panel;
wherein the panel is configured to contain an animal within the containment crate system;
the first door having a plurality of eyes;
the first door having a drop rod;
wherein the plurality of eyes are configured to receive the drop rod, thereby operatively connecting the first door to the at least one horizontal plate;
a floor assembly;
the floor assembly having a generally flat surface;
the floor assembly configured to enclose the bottom of the containment crate system.

33. A livestock confinement crate system comprising:
at least one rib;
the at least one rib each having an upper portion, a middle portion, and a lower portion;
the at least one rib each extending a length from a first end to a second end;
at least one horizontal plate;
the at least one horizontal plate extending a length from a first end to a second end;
the at least one horizontal plate having a plurality of positioning holes;
wherein the at least one horizontal plate is connected to the at least one rib;
at least one end rod;
the at least one end rod extending a length from a first end to a second end;
wherein the at least one end rod is connected to the first end of the at least one horizontal plate;
a first door;
the first door having a panel; wherein the panel is configured to contain an animal within the containment crate system;
the first door having a plurality of eyes;
the first door having a drop rod;
wherein the plurality of eyes are configured to receive the drop rod, thereby operatively connecting the first door to the at least one horizontal plate;
a floor assembly;
the floor assembly having a generally flat surface;
the floor assembly configured to enclose the bottom of the containment crate system;
a containment area;
the containment area having a forward end and a rearward end;
wherein the containment area is formed by the at least one rib, the at least one horizontal plate, and the first door being operatively connected and configured to receive an animal therein.
